(19) United States
(12) Patent Application Publication
(10) Pub. No.: US 2012/0095798 A1
(43) Pub. Date: Apr. 19, 2012

(54) MANAGEMENT OF MARKETING COMMUNICATIONS

(75) Inventor: DEBBIE R. MABARI, LUTZ, FL (US)

(73) Assignee: CODY HEALTH SOLUTIONS LLC, Tampa, FL (US)

(21) Appl. No.: 12/968,867

(22) Filed: Dec. 15, 2010

Related U.S. Application Data
(63) Continuation-in-part of application No. 12/893,921, filed on Sep. 29, 2010, now abandoned.
Application No. 12/893,921 is a continuation-in-part of application No. 12/787,083, filed on May 25, 2010, now abandoned.
(60) Provisional application No. 61/182,555, filed on May 29, 2009.

(51) Int. Cl. G06Q 10/00; G06Q 40/00; G06Q 30/00

(52) U.S. Cl. 705/7.15; 705/7.17; 705/7.36

(57) ABSTRACT

A computerized publication management system and method of use are provided for managing the marketing communications development process for healthcare and other highly regulated entities. The method involves receiving a number of inputs that define a desired marketing communication via a graphical user interface of the publication management system. Based on an analysis of the inputs, the publication management system may determine a number of tasks to be completed over the course of a marketing communications project and assign each of the tasks to appropriate personnel and/or service groups within the entity. The tasks may include, for example, obtaining appropriate approvals, copywriting, editing and proofing, print vender selection and management, and so on. Using the tasks and their assignments, the system may determine a workflow path and timeline for the project and track and manage the completion of the project as it progresses through the workflow path. The system may also automate certain processes associated with the development of marketing communications. For instance, the system may generate or select model documents and may implement an automated process for customizing versions and/or individual instances of any given marketing communication.

### CROSS-REFERENCE TO RELATED APPLICATION

This application is a continuation-in-part of U.S. patent application Ser. No. 12/893,921, entitled “MANAGEMENT OF HEALTHCARE MARKETING COMMUNICATIONS,” filed on Sep. 29, 2010, which is a continuation-in-part of U.S. patent application Ser. No. 12/787,083, entitled, “MANAGEMENT OF HEALTHCARE MARKETING COMMUNICATIONS,” filed on May 25, 2010, which claims priority from U.S. Provisional Application No. 61/182,555, entitled “MANAGEMENT OF HEALTHCARE MARKETING COMMUNICATIONS,” filed on May 29, 2009, the contents of all of which are incorporated herein as if set forth in full.

### FIELD OF INVENTION

The present invention relates generally to managing the development of marketing communications by healthcare entities and pharmacy benefit management companies, financial institutions, insurance companies, and other highly regulated entities. In particular, the present invention relates to improving coordination and workflow in connection with such communications to enhance effectiveness, accuracy, and regulatory compliance.

### BACKGROUND OF THE INVENTION

Healthcare entities in the payer space such as, for example, managed healthcare providers, planned benefit package providers, insurance companies, and pharmacy benefit managers and payers, as well as healthcare entities in the provider space such as, for instance, hospitals, medical clinics, and other medical provider facilities, generate a large volume of marketing communications. For example, these communications may be directed to prospective and/or current members and may include communications such as, for example, membership identification materials, summary plan descriptions, annual notifications of change (ANOCs), formularies, provider directories, member handbooks, and other materials. These marketing communications may be electronic and/or print communications delivered through a variety of channels (e.g., email, direct mail).

Healthcare entity marketing communications are subject to a complex framework of regulations, including both United States federal and state regulations that are intended to protect consumers. These regulations may impact, among other things, the content (accuracy and completeness), timing (e.g., 5 days, 10 days or 45 days from various trigger events), delivery mode, and required recipients of such communications. Failure to satisfy these regulatory requirements can result in sanctions including requirements to suspend or cease enrollments, as well as potential civil and even criminal liability.

In addition to these regulatory requirements, well-run healthcare entities typically have a number of internal objectives concerning these marketing communications that extend beyond satisfying the minimum regulatory requirements. These may include providing the most effective and useful information to the intended audience of the communications, ensuring that a subject matter expert has reviewed the communication for accuracy and completeness, maintaining consistent standards in connection with all copy relating to quality, branding, and the like, and minimizing distribution costs (which impacts costs to the members and the public) while satisfying the noted objectives.

The effect of all of this is that healthcare entities are required to become experts in the art of generating and disseminating marketing communications, even though this function is often not initially perceived as a primary operational objective and does not match the core competencies of healthcare entities. Moreover, all of this must be accomplished in relation to a complex array of different benefit plans, ever-changing distribution lists, regulations, trigger events and government programs. Moreover, generation of these communications is an intensely interdisciplinary process involving, to name a few, creative product teams, plan specialists, compliance officers, consumer advocates, subject matter experts, information technology specialists, data managers, and print and fulfillment solution providers. Thus, marketing communications development would be challenging even if deadlines were flexible but, as noted above, the regulatory driven deadlines are inflexible and the consequences of failing to meet the deadlines are devastating and costly.

Consequently, some healthcare entities have been unable to meet the requirements for marketing communications, in many cases despite their best efforts and have suffered the repercussions. Indeed, in a number of cases, healthcare entities have been suspended from enrolling new members or closed at least in part due to allegations of failing to comply with regulations concerning marketing communications or disseminating inaccurate information.

Others entities have compromised on some of the objectives noted above to meet the requirements. As a practical matter, this sometimes means that in order to meet requirements for timeliness and content, health entities have not been able to provide the most effective documents in the most efficient manner, all to the detriment of consumers and members. In this regard, a significant competitive opportunity exists for any healthcare entity that can streamline, automate, and/or integrate the process of managing marketing communications projects to fully address the objectives noted above.

### SUMMARY OF THE INVENTION

The present inventors have recognized that these issues may be addressed through the implementation of a tool for providing integrated management of marketing communications projects. Regardless of the structure or organizational model of the entity, the tool provides and manages customized workflow processes that instill the discipline necessary to develop effective marketing communications efficiently and within regulatory constraints, while harnessing and managing the capabilities of subject matter experts, audience champions, and sophisticated information technology and data management techniques. The tool also automates aspects of the marketing communication development process, including aspects of the processes of generating, customizing, and producing marketing communications and managing post-development inventory to promote conscientious storage, use, and purging of inventory.

As a result, healthcare entities are able to develop marketing materials of reliable accuracy and usefulness to the intended audience in a timely and budget conscious manner, all to the great benefit of consumers and members. All of this is accomplished in an environment where entities have struggled to meet basic regulatory requirements, much less meet the aspirations of marketing professionals charged with developing such communications. Indeed, the present invention allows such communications to satisfy needs that current marketing professionals have not even recognized.

Notably, while present invention is discussed in terms of marketing communications for healthcare entities, the tool may be used to provide integrated management services for the development of marketing communications within any appropriate entity, including, for example, financial institutions, insurance providers, and generally any entity involved in the development of highly regulated marketing communications.

In accordance with a first aspect of the present invention, a novel method is provided for developing marketing communications for a healthcare entity. The method involves establishing a computerized system for integrated publication management. The computerized system may include a processor and associated logic that incorporates any appropriate combination of hardware, software, and/or firmware necessary to implement the desired publication management functionalities described herein. The processor may be communicatively linked with one or more memory structures as well as one or more clients. In one embodiment, the computerized system may be maintained in an Internet-based computing environment such that the software executing on the computerized system may be provided as a service to customers on a subscription basis.

The method also involves receiving, through a graphical user interface of the computerized system (e.g., a computerized interface that enables user interaction with the system), inputs regarding a marketing communications project to generate a defined marketing communication. Based on the inputs to the graphical user interface, the computerized system determines a workflow path and a timeline for generating, approving, producing, and delivering the defined marketing communication and routes the marketing communications project to each of a subset of service groups of the healthcare entity that are required to carry out the workflow path over the timeline.

The inputs may be provided through a project request form that is accessible through the graphical user interface. The project request form may include a number of input prompts that allow a user to define the marketing communication, and the input prompts may be structured in any appropriate manner. For example, the inputs may be structured as drop-down menus and/or check-boxes offering pre-defined selections or the inputs may simply include text boxes for the user to define particular requirements, criteria, and/or requests.

The inputs may include any information that is relevant to the development of the marketing communication, including, for example, a business department, product group, and/or line of business associated with the request, a media type, one or more plan types or numbers to which the marketing communications project pertains, an intended audience, a goal or purpose of the communication, budgetary information, print and/or production guidelines, and compliance and/or approval requirements (e.g., whether managerial approval is required, whether governmental regulatory approval is required). The inputs may also include requests for services provided by one or more of the service groups of the healthcare entity. The service groups may include any groups or divisions within the healthcare entity that are involved in the functions of generating, approving, producing, and delivering marketing communications of the healthcare entity. For example, in one healthcare entity, the service groups may include a product or line of business group, a marketing and communications/creative services group, a compliance group, an information technology and data development group, an operations group, and a customer service group. The service groups and their associated functions may operate under any appropriate group titles, and the group structure may differ for each entity.

Upon receipt of the inputs, a traffic manager may review the inputs to determine whether to refuse, approve, or retain the project request as pending while additional information is ascertained. Once approved, the computerized system may analyze the inputs to develop the workflow path and the timeline. In one embodiment, this process may involve determining a number of tasks to be completed over the course of the marketing communications project and assigning each of the tasks to a subset of the users and/or service groups functioning within the entity. For example, based upon an analysis of the inputs, the system may identify, among other things, any required regulatory approvals, an appropriate subject matter expert to include in the workflow path, an appropriate audience champion, corresponding service groups for inclusion in the workflow path, and any necessary timeframes.

In one implementation, the system may also assign a project stage to each of the tasks. The project stage defines when a particular task should be completed in relation to the remaining tasks. By analyzing the tasks, their assigned users and stages, as well as a project start and end date, the system may determine the workflow path and the timeline for generating, approving, producing, and delivering the defined marketing communication to be developed over the course of the marketing communications project.

In one embodiment, the process of generating the defined marketing communication may involve generating one or more drafts (e.g., a single draft or a progression or series of drafts) of the marketing communication that will ultimately be produced and delivered to one or more recipients. An initial draft may be based on the inputs to the project request form as well as a template, or model document, provided by an appropriate governing body (e.g., the Centers for Medicare and Medicaid Services (“CMS”)). The draft may be used for submission to the regulatory body (e.g., CMS) for approval, and in some embodiments, additional drafts may be generated as users add or revise content based on numerous considerations (e.g., editing and proofreading, necessary revisions to obtain regulatory approval).

The process of approving the marketing communication may involve obtaining approval of the marketing communication from any appropriate source. In many instances, a subject matter expert may review and approve the draft marketing communication to ensure that the substantive content of the marketing communication is both accurate and complete. An audience champion may also review the draft marketing communication to enhance the effectiveness of the communication to the intended audience. For example, the audience champion may review the structure, content, and tone of the communication to ensure that the communication will effectively convey the desired information to the recipients. Managerial approval may also be required in certain instances. For instance, a manager within the product group that has requested the marketing communication may need to review and provide approval at certain stages of the marketing communications project to ensure that the project stays within budgetary constraints. In addition, many marketing communications are regulated by one or more regulatory bodies. These marketing communications may be subject to regulatory approval by one or more state or federal agencies to ensure that the marketing communications comply with applicable regulations. In these instances, the process of approving may involve submitting a draft of the marketing communication to the appropriate regulatory body for compliance approval. This submittal may be automated such that the computerized publication system electronically communicates with the appropriate regulatory body to submit the draft and to obtain the requisite regulatory approval (e.g., through an electronic health record and practice management system). Additionally or alternatively, the system may be used to generate an electronic compliance record that reflects when a marketing communication was submitted to a regulatory body for approval as well as the status of the approval.

The process of producing the marketing communication may involve creating one or more electronic or print instances of the marketing communication for delivery to the recipients. That is, the process of producing the marketing communication may involve printing identical copies or, if appropriate, a customized instance of the marketing communication for each recipient. Alternatively, the step of producing may involve generating electronic documents (e.g., PDFs, Excel spreadsheets) for electronic delivery to recipients. In one embodiment, a print production or fulfillment process may be executed through an outsourced printer or production specialist. In this embodiment, the workflow path may include tasks such as obtaining one or more bids, selecting a vender, placing orders, reviewing proofs, and so on.

The process of delivering the marketing communication may involve any appropriate mechanism for providing the marketing communication to the recipients. For example, a print marketing communication such as a letter, postcard, flyer, brochure, manual, or the like, may be mailed to recipients. Electronic communications may be emailed to recipients or they may be posted in a centralized portal that provides users with electronic access to the communication. For example, electronic communications may be posted to users' password-protected online membership accounts.

To route the marketing communication project through the workflow path as it progresses through the development process, or through the generation, approval, production, and delivery processes, the computerized system may provide centralized access to the workflow path as well as the tasks that form the workflow path. As tasks are completed, the system may track the status of each task and report the status of the task as well as the project as a whole through the graphical user interface or, in another embodiment, through email notifications to users. In this regard, users within the service groups that have been assigned to one or more tasks may review the workflow path and act to complete their respective tasks as specified. The computerized system may also include a library to electronically store project materials such that they are centrally available to users within the service groups. For example, as discussed in further detail below, the system may be used to generate and/or store templates or model documents that serve as initial drafts of the marketing communication. Oftentimes, templates may be provided by regulatory agencies such as, for instance, CMS.

The library may also store a variety of assets (e.g., content blocks, disclaimer language, copy blocks, images or graphics, data files) that, along with the template, serve as building blocks for generating the marketing communication. Further, as the marketing communications project progresses, drafts of the marketing communication may be stored within the system. The project materials may be organized in any appropriate manner that allows users to easily access and manage project materials and their respective tasks. The graphical user interface may also include a mechanism for communication between users or team members, allowing users to centrally comment on project issues, problems, successes, milestones, and the like.

Another aspect of the present invention provides a system for use in developing marketing communications for a healthcare entity. The system includes a publication management computer having a graphical user interface for defining a marketing communications project. The graphical user interface has numerous input prompts that are associated with a predefined menu of user inputs including one or more of a plan benefit package to which the marketing communications project pertains, information identifying a media type of the project, information identifying an intended audience for the project, and an indication of whether managerial approval is required. The publication management computer is configured to define and manage a comprehensive workflow path for developing the marketing communications project based on the user inputs to the graphical user interface.

The publication management computer may further be configured to route, or usher or marshal, the marketing communications project to numerous users and/or service groups that comprise the comprehensive workflow path. As discussed above, each of the service groups may perform one or more tasks that are necessary to the development of the marketing communication, and the service groups may include any appropriate functional group within a healthcare entity such as, for instance, a product group, a design group, a copywriting group, a proofing and editorial group, a print productions group, a translations group, a compliance group, an operations group, an inventory management group, and/or a customer service group.

Employing this type of subject matter segregated model for developing marketing communications allows expertise to be effectively managed and leveraged with respect to individual marketing communications projects. Moreover, this type of subject matter segregated approach allows for a high degree of expertise to be developed within each service group to enhance accuracy, effectiveness, and regulatory compliance. In one embodiment, an account executive and/or a traffic manager may review the comprehensive workflow path and make any adjustments or modifications that are necessary before the publication management computer is implemented to manage the project as it progresses through the workflow path. The account executive and/or traffic manager may have pre-existing subject matter expertise relating to, for example, Medicare, Medicaid or other government and non-government or commercial programs associated with such communications.

Yet another aspect of the present invention provides a method for managing marketing communications traffic within a healthcare entity. The method involves establishing a computerized publication management system for managing a marketing communications project for developing a marketing communication and using the computerized publication management system for receiving designated criteria or inputs that define the project before applying pre-defined rules to the criteria to generate, select, and/or customize a template for the marketing communication. The method also involves using the computerized publication management system to identify a project set of service groups for inclusion in a traffic flow for the marketing communications project and for determining a workflow path with regard to the identified project set of service groups. The project set of service groups is selected from a master set of service groups for potential use in project workflows that includes a product group, a design group, a copywriting group, a proofing and editorial group, a print productions group, a translations group, a compliance group, an operations group, an inventory management group, and a customer service group.

The computerized publication management system, in applying the pre-defined rules to the designated criteria or inputs, may assemble one or more assets stored in a memory structure of the system to form or customize the template. As discussed above, the assets may include items of content such as substantive content or copy blocks, images, graphics, disclaimer blocks, application programming interface links, headers, footers, data files for use in customizing variables contained within the template, and the like. The assets may be viewed as building blocks that, in combination with the template, form a draft of the marketing communication. In applying the pre-defined rules to the inputs, the system is able to select appropriate assets. For example, if the input criteria specify that the media type is an ANOC and the plan type is a Medicare Part D plan, the pre-defined rules may mandate the inclusion of certain regulatory disclaimers for that particular marketing communications project.

The rules may also embody select government regulations that mandate the content contained within medical marketing communications. For example, the rules may incorporate content-associated requirements (e.g., certain media types must include specified content) as well as usage-associated requirements (e.g., certain content must be used in a specified way).

In one embodiment, the template may be versioned according to common subsets of the assets. That is, the system may generate one or more versions of the template, where each version includes a common asset subset. Returning to the example above, a template for an ANOC that pertains to Medicare Part A, B, C, and Ds plans may be versioned according to the relevant plan. In another example, a template for an ANOC that pertains to a Medicare Part A plan may be versioned according to common annual coverage limitations: A first version may include assets relating to member coverage up to but not exceeding a first limit and a second version may include assets relating to member coverage up to but not exceeding a second limit.

One or more instances of the marketing communication may be produced from either the template (or the template as revised during the development process) or any one of the template versions (or one or more of the versions as revised during the development process). The instances of the marketing communication represent the final electronic or print communications for delivery to the intended recipients. Each instance may be customized in that the template and/or template versions may be merged with individualized member data to create customized instances of the marketing communication. In one embodiment, the production process may occur within the entity. Alternatively, the system may be used to submit the template or the version(s), along with data files including member information (e.g., flat text files, delimited text files, CSV files) to an external vender for print production and delivery services.

Because the computerized publication management system may be implemented to manage the development of marketing communications within a variety of different healthcare entities in both the payer space and the provider space, the system may be customized to accommodate the particular needs of each entity. Prior to an entity's first marketing communications project, the utility may undergo an implementation phase in which the project request form, pre-defined template rules, assets, and the like are customized to reflect the entity's organizational structure, policies, and business practices. The rules may also be customized on a project-by-project basis.

In accordance with another aspect of the present invention, a method is provided for managing the development of regulated marketing communications. The method initially involves establishing a computerized system for integrated publication management and using the computerized system for determining a workflow path for generating, approving, producing, and delivering defined marketing communications including print and electronic communications. The method also involves using the computerized system in connection with the workflow path for (1) receiving a request regarding a first marketing communication; (2) determining a subject matter area and intended audience for the first marketing communication; (3) generating a draft of the first marketing communication; (4) based on the subject matter area and intended audience, determining whether the draft requires approval from a subject matter expert, an audience champion, or a regulatory body, and (5) where the draft requires approval, obtaining the approval from one or more of an appropriate subject matter expert, an appropriate audience champion, and an appropriate regulatory body.

In one embodiment, the step of obtaining approval from the regulatory body involves submitting the draft of the first marketing communication to the regulatory body for approval and tracking the status of the approval process. This submission may occur automatically and electronically via the publication management system.

In another embodiment, the method further involves executing a fulfillment process that is dependent on a print or electronic nature of the first marketing communication. The fulfillment or production process may be completed in-house by one of the service groups of the entity or it may involve using the computerized system to submit the first marketing communication to an external print vender for production and delivery.

An additional aspect of the present invention provides a system for managing regulated marketing communications in a healthcare entity. The system includes a database for storing information relating to regulations governing marketing communications for healthcare entities and a computerized publication management system associated with the database. The computerized publication management system is configured for receiving inputs defining a proposed marketing communication. Based on the inputs, the system identifies one or more of the regulations that govern the proposed marketing communication, and based on the governing regulations, the system determines a workflow path for generating, approving, producing, and delivering the proposed marketing communication.

In many cases, marketing communications need to be customized to include information that is unique to each instance of the marketing communication. For example, a marketing communication may apply to a number of different plans and/or each instance of a marketing communication may include member variable information that is specific to the plan involved, the plan options selected by a member, the identity of the member, a group membership or other status of the member, among other variables. Such custom content typically appears in many places throughout the marketing communication including, for example, in portions relating to premium amounts, co-pay amounts, coverage limitations, and the like.

Obtaining the necessary approvals (e.g., regulatory approvals, subject matter expert and audience champion approvals, managerial approvals) and generating numerous customized instances of the marketing communication due to permutations of the variable information, all within the required timeframe, is a difficult challenge for healthcare entities and other publishers within highly regulated industries. In this regard, and as discussed above, the process for developing marketing communications may involve storing or generating a base document or template for the marketing communication. This template may include fixed content that requires one or more approvals and may be submitted to the appropriate service groups and/or regulatory bodies for approval. After the template or a draft marketing communication developed from the template is finalized, and after the review and approval process is complete, customized instances of the marketing communication may be produced from the template to address the various variables noted above. In this regard, the adaptations required to customize the marketing communication are often quite substantial, and accuracy is very important. Moreover, due to the uncertain timeframes associated with developing the marketing communication, obtaining the requisite approvals, and complications associated with any necessary revisions, the time available to generate the different versions may be severely limited.

To address this need for accurate and efficient customization, a further aspect of the present invention provides a method to facilitate customization of a marketing communication. The method initially involves establishing a computerized system for integrated publication management and using the computerized system for (1) receiving inputs that define a prospective marketing communication having a fixed content and a custom content, wherein the custom content varies with respect to one or more variables including an intended audience, a plan, a plan option, a plan year, member identity, member organization, or member status; (2) developing a communication template for use in obtaining approvals for the fixed content of said marketing communication; (3) establishing a metadata repository for representing the custom content of the prospective marketing communication, where items of the custom content are represented by tokens in the communication template; (4) developing a mapping structure for use in populating the items of custom content based on the variables; and (5) producing a number of customized instances of the prospective marketing communication by obtaining a tokenized variation of the marketing communication including a content of the template and the tokens, and replacing the tokens with corresponding items of custom content based on said metadata repository and the mapping structure. In one embodiment, the fixed content comprises regulated content that is subject to approval by a regulatory body such as the Centers for Medicare and Medicaid Services (“CMS”) or the Department of Health and Human Services. As discussed above, the approvals may include any necessary approvals including, for example, regulatory approval, managerial approval, approval by a subject matter expert, and/or approval by an audience champion. In addition, the custom content may include any appropriate content for customization such as, a plan name, premium information, deductible and/or copay information, co-insurance information, benefit information, member organization information, and the like.

The metadata repository may be established to represent the custom content with tokens or wildcards. That is, the items of custom content may be further defined by metadata within the metadata repository (e.g., being implemented by an XML tag structure or schema or within a CSV file). For example, if a particular item of custom content relates to a co-pay for a particular event for a specified plan and plan option, the tag structure may define the subject matter (a co-pay), the type of event, the plan, and the plan option.

The mapping structure may be developed for use in populating the items of custom content. Thus, token values may be indexed to corresponding elements of the metadata repository. A number of customized instances of the prospective marketing communication can then be generated by obtaining a tokenized variation of the marketing communication that includes a content of the template or the version, discussed above, and the tokens and then replacing the tokens with corresponding items of custom content based on the metadata repository and the mapping structure. In this regard, a process for cross-walking data items or files from a table of member data (within the metadata repository) to the marketing communication can thereby be programmed for automation. In this manner, generation of a large number of highly customized instances of the marketing communication can be accomplished both efficiently and accurately.

### BRIEF DESCRIPTION OF THE DRAWINGS

For a more complete understanding of the present invention and further advantages thereof, reference is now made to the following detailed description taken in conjunction with the drawings in which:

FIG. 1 shows a diagram presenting numerous exemplary service groups that are involved in developing marketing communications within a healthcare entity;

FIG. 2 illustrates one embodiment of a publication management system for integrated publication management for healthcare entities;

FIG. 3 illustrates one embodiment of a processor operating within the publication management system of FIG. 2;

FIG. 4 illustrates one embodiment of an implementation protocol for execution in relation to the healthcare entity;

FIG. 5 illustrates an exemplary workflow management protocol;

FIG. 6 illustrates a screenshot of one embodiment of a project request form that is accessible through a graphical user interface of the publication management system of FIG. 2.

FIG. 7 illustrates a screenshot of the project request form of FIG. 6;

FIG. 8 illustrates an additional screenshot of the project request form of FIG. 6;

FIG. 9 illustrates another screenshot of the project request form of FIG. 6;

FIG. 10 illustrates yet another screenshot of the project request form of FIG. 6;

FIG. 11 an additional screenshot of the project request form of FIG. 6;

FIG. 12 illustrates a screenshot showing numerous project schedules maintained within the publication management system of FIG. 2;

FIG. 13 illustrates a screenshot of one embodiment of a project schedule editor of the publication management system of FIG. 2;

FIG. 14 illustrates and exemplary reporting and metrics protocol;

FIG. 15 illustrates a screenshot of one embodiment of a homepage of a graphical user interface of the publication management system of FIG. 2;

FIG. 16 illustrates a screenshot of one embodiment of an asset loading tool of the publication management system of FIG. 2;

FIG. 17 illustrates a screenshot of one embodiment of an asset index available through the publication management system of FIG. 2;

FIG. 18 illustrates a screenshot of one embodiment of an asset search tool available through the publication management system of FIG. 2;

FIG. 19 illustrates a screenshot of one embodiment of a versions library available through the publication management system of FIG. 2;

FIG. 20 illustrates a screenshot of one embodiment of a rule wizard available through the publication management system of FIG. 2;

FIG. 21 illustrates an exemplary rules creation and application protocol;

FIG. 22 illustrates a graphical depiction of a template versioning concept implemented by the publication management system of FIG. 2;

FIG. 23 illustrates one embodiment of a customization protocol for producing numerous customized instances of a desired marketing communication;

FIG. 24 illustrates one embodiment of an inventory index available through the publication management system of FIG. 2;

FIG. 25 illustrates an exemplary marketing communications project development protocol; and

FIG. 26 illustrates an exemplary workflow path for routing a marketing communications project.

FIG. 27 illustrates one embodiment of a template containing several rule insertion opportunities for template versioning and customization.

FIG. 28 illustrates one embodiment of a template version.

### DETAILED DESCRIPTION

The following description describes exemplary embodiments of an improved system and method for managing the development of marketing communications of healthcare entities and other highly regulated entities such as financial institutions, insurance companies, and the like. For clarity purposes, this discussion focuses on a system and method for managing the development of marketing communications of healthcare entities. More specifically, the description details embodiments of a system and method for managing the processes of generating, approving, producing, and delivering defined marketing communications across numerous service groups of a healthcare entity in an integrated manner. To guide a detailed discussion, the following description is divided into a number of sections. Section I describes the setup of an exemplary healthcare entity and the general functions of several service groups within the healthcare entity. Section II describes the architecture and functionality of an exemplary publication management system for use in the integrated management of marketing communications projects within the healthcare entity. Section II also details how the functions of each of the service groups of the healthcare entity are cohesively managed, and sometimes automated, through the publication management system. This discussion describes several mechanisms that enable the publication management system to assist the healthcare entity in developing more effective marketing communications in less time at a lower cost. Section III describes an exemplary protocol for use in developing a marketing communication using the publication management system.

While the embodiments described below involve the development of marketing communications for healthcare entities, it should be understood that the publication management system may be implemented to manage the development of marketing communications within other types of entities including, for example, banking and financial institutions and agencies providing insurance plans other than healthcare insurance plans such as home insurance, car insurance, business liability insurance, and so on. The publication management system may also be employed to manage the development of marketing communications within third-party administrator organizations (“TPAs”) that provide business-process-outsourcing services to the health plan market and other highly regulated markets. The publication management system described below is particularly helpful in the TPA environment because TPAs offer managed publication development services to multiple entities whose publications must remain separate and distinct. For example, a well-known TPA, TMG Health, provides marketing communications services to the government health plan market and serves dozens of separate health plan providers ranging from large, multi-state and national plans with hundreds of thousands of members to small, regional plans with only a few thousand members. While managing the development of marketing communications for a single entity is a complex task, separately managing the development of marketing communications for each of numerous entities having differing company hierarchies, business practices, schedules, and confidentiality requirements is especially difficult and is well suited for management via the publication management system discussed below. In sum, the publication management system may be used to manage the development of any type of customized marketing communications that require a number of interdisciplinary contributions from across one or more entities.

### I. The Healthcare Entity

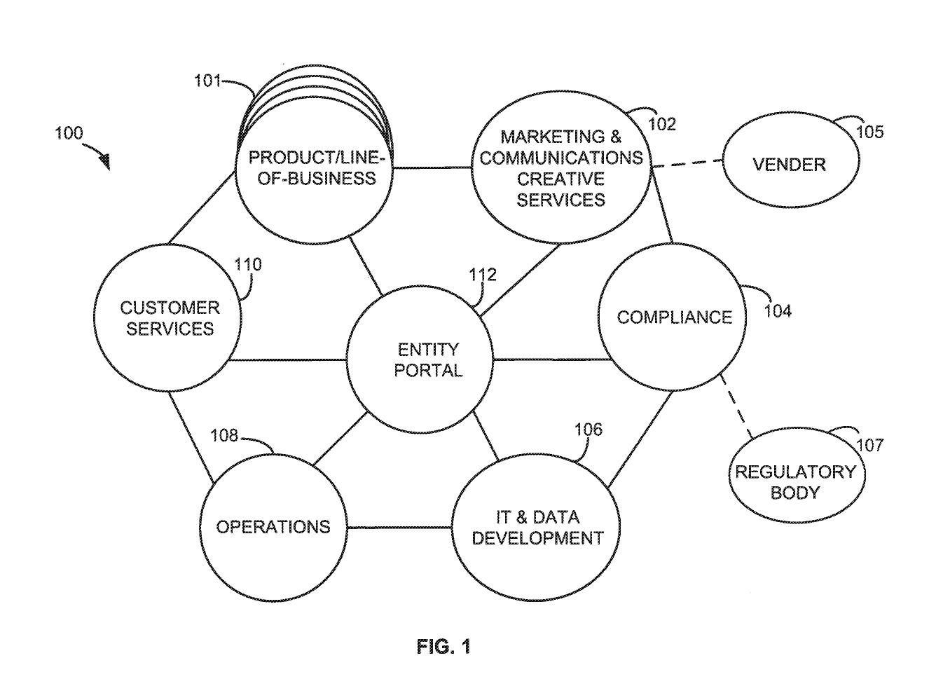

FIG. 1 graphically depicts numerous exemplary service groups that are generally involved in the processes of generating, approving, producing, and delivering marketing communications of a healthcare entity 100. These services groups may include, for example, a product or line-of-business group 101 (hereinafter the “product group”), a marketing and communications/creative services group 102 (hereinafter the “MarCom group”), a compliance group 104, an information technology and data development group 106 (hereinafter the “IT group and data development group”), an operations group 108, and a customer service group 110. The service groups 101-110 may link to an entity portal 112 (e.g., an intranet or extranet site) through which personnel within the groups 101-110 may access, retrieve, or provide information that is relevant to each particular group's function.

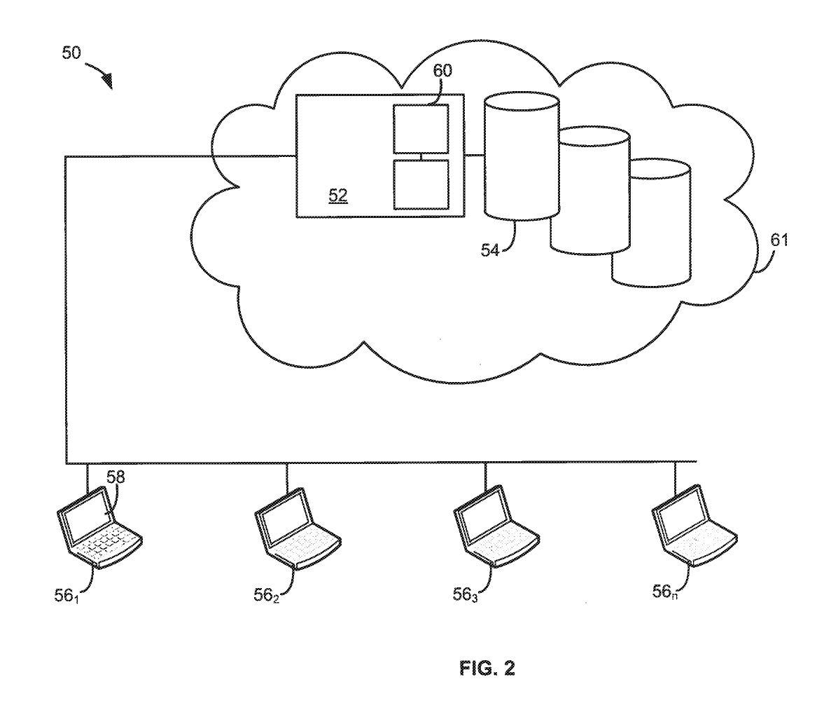

While each of the service groups 101-110 will be discussed in greater detail below in relation to embodiments of an exemplary publication management system 50 (FIG. 2) that integrates the service groups' functionalities and routes (e.g., manages, ushers, or marshals) marketing communications projects as they move between the service groups 101-110, an initial discussion of the service groups 101-110 and their general functions is helpful in fully comprehending the complexity of marketing communications projects and the need for integrated management of such projects. To begin, the exemplary healthcare entity 100 may include numerous creative product groups 101. Each of the product groups 101 may administer particular health benefit products such as, for example, Medicare products, Medicaid products, or commercial insurance products. Any one of the product groups 101 may initiate a marketing communications project to develop a defined marketing communication that conveys desired information to identified recipients. In initiating the marketing communications project, individuals within the product group 101 may define the desired marketing communication by providing several defining parameters such as identifying the department making the request (e.g., sales, training, wellness, member services, marketing, HR, legal), identifying the plan type to which the marketing communication pertains (e.g., private fee for service, Medicare Advantage, Medicare Part D, HMO, PPO, long-term care), and identifying the media-type of the marketing communication (e.g., an ANOC, a banner, a billboard, a flyer, an ID card, a formulary, a letter, a newsletter, a new release, a postcard, an eBlast, a provider directory). The product group 101 may also specify an audience to receive the marketing communication (e.g., brokers, internal employees, members, member prospects, providers, members of the public), explain the purpose to be achieved with the marketing communication, specify any requisite approvals (e.g., managerial, regulatory compliance, audience champion, subject matter expert) and provide a due date for the request.

Using the parameters provided by the product group 101, the MarCom group 102 may provide a number of services as needed and/or requested. These services may include design, copywriting, proofing and editorial, translation management, compliance, print production services that include managing the bid process and selecting and managing an external print vender 105, and/or inventory management services relating to existing and/or archived marketing communications inventories.

The compliance group 104 may direct a compliance review of the marketing communication. In this regard, the compliance group 104 may first determine if approvals are required and/or appropriate and, if approvals are required, what type of approvals are necessary. For example, certain marketing communications may require review and approval by a subject matter expert to ensure that the content of the communication is accurate and complete and that the communication is consistent with all copy relating to quality, branding, and the like. Other marketing communications may benefit from review by an audience champion to ensure that the communication effectively conveys the desired information to the intended audience. Still other marketing communications may require approval from one or more levels of management within the healthcare entity 100 (e.g., managers within the product group 101). Such managerial approval may be required for any appropriate reason such as, for instance, to ensure that the marketing communication complies with applicable budgetary constraints or internal policies of the healthcare entity 100.

As discussed above, some marketing communications may require approval from one or more regulatory bodies 107 that are external to the healthcare entity 100. For example, a marketing communication may require review and approval by the Centers for Medicare & Medicaid Services (“CMS”), which is the United States federal agency that administers Medicare, Medicaid, and the Children's Health Insurance Program. In these instances, the compliance group 104 may take responsibility for obtaining the requisite governmental approvals. This may initially involve obtaining template or model documents from the relevant regulatory body (e.g., CMS) for use in generating marketing communication drafts. In may also involve submitting the drafts of the marketing communications to the appropriate regulatory body and addressing any formalities required by the regulatory body to obtain approvals. If the draft of the marketing communication is not approved, the compliance group 104 may oversee amendments and/or revisions to the draft. For example, the compliance group 104 may make revisions to the draft (e.g., adding or removing disclaimers) or return the draft to the MarCom group 102 for revisions to the copy.

In the context of developing marketing communications, the information technology and data development group 106 may serve multiple functions. In a first capacity, the IT and data development group 106 may manage one or more electronic health record and practice management systems (“HPMS systems”) on behalf of the healthcare entity 100. Such systems are used to maintain electronic health and billing records, rather than paper records, for the entity's members. Either through these electronic health record systems or by manually examining paper records, the IT and data development group 106 may access and store member information. In this regard, the IT and data development group 106 may develop and maintain a database that includes member variable data such as member names, mailing addresses, and plan numbers along with applicable plan deductibles, benefit limits, and/or co-pays associated with the member plans. This stored metadata may then be used to customize instances of the marketing communication for each recipient. That is, the member variable data may be represented, for example, in flat text, tab delimited, or comma-separated value (“CSV”) files and merged with tokenized variations of the marketing communication at the printer or, in an electronic alternative, at a PDF writer.

All or part of the production of either the print or electronic documents may be performed in-house at the healthcare entity or partially or entirely at one or more external venders 105. For example, as part of its print production services function, the MarCom group 102 may merge the member variable data files with the tokenized variations of the marketing communication before producing customized instances of the print or electronic marketing communication internally. Alternatively, the MarCom group 102 may provide a fully realized print stream to the external vender 105 for final printing and/or PDF production. In another embodiment, the MarCom group 102 may merely provide separate data and document files to the outside vendor(s) 105 for independent merging and printing and/or electronic production. Similarly, the healthcare entity 100 may address delivery of the marketing communication (e.g., mail, electronic delivery) either internally or it may contract with the outside vender 105 to carry out defined delivery options.

In a capacity similar to the IT and data development group 106, the operations group 108 may gather, maintain, and/or manage payer and/or provider network information such as, for example, provider directory information including lists of medical providers, their practice areas, contact information, associated benefit plan information, and so on. The payer and/or provider network information may also include formulary information summarizing prescription drug coverage available under various plan benefit packages. Like the member variable data collected and managed by the IT and data development group 106, the provider network information may be applied to customize instances of the marketing communication, as discussed above. That is, the provider network information may be represented in data files (e.g., flat text, tab delimited, CSV files) and merged with tokenized variations of the marketing communication at the printer and/or PDF writer, allowing each instance of the marketing communication to reflect customized provider information as appropriate and necessary.

The customer service group 110 may collect customer feedback in a variety of ways. For example, the customer service group 110 may employ customer relationship management software to interact with members and prospective members to collect information and to provide voice-of-customer feedback to the product group 101 as well as any of the remaining service groups 102-108 within the healthcare entity 100 regarding the effectiveness of the entity's marketing communications. This feedback may be used to improve the effectiveness of future marketing communications.

II. The Publication Management System As may be apparent to one of ordinary skill in the art, managing the development, or the creation, approval, production, and delivery, of marketing communications projects as they move between appropriate ones of the contributors discussed above is a functionally and temporally complex task. To address these complexities, FIG. 2 shows an exemplary embodiment of a publication management system 50 to provide integrated marketing communications management for healthcare entities. The publication management system 50 may be used to manage the functionalities of the numerous service groups 101-110 in an integrated and cohesive manner. As discussed above, each of the service groups 101-110 may contribute defined functions to the processes of generating, approving, producing, and delivering both electronic and print marketing communications. In this regard, the publication management system 50 may assess the functional demands of each marketing communications project, determine an appropriate workflow and timeline for the project, and route or marshal the marketing communications project through appropriate ones of the service groups 101-110 and their associated personnel. That is, in one embodiment, the publication management system 50 may be implemented to assess a set of defining criteria and to determine a project workflow, timeline, and associated tasks for completion.

Once the workflow is established, the publication management system 50 may be used to distribute (e.g., via email) and/or centrally publish the workflow to contributing personnel within each of the service groups 101-110 and to monitor and report on the status of each task as it is completed. As discussed below, the publication management system 50 may also be implemented to streamline and automate previously manual functions as well as leverage common assets and work performed in relation to previous marketing communications projects.

In this embodiment, the publication management system 50 may include a server 52 that is associated with one or more memory structures 54. The server 52 may also communicatively link to a number of client nodes 56₁₋ₙ that are distributed throughout the service groups 101-110 and accessible to users within the various service groups 101-110 of the healthcare entity 100. The server 52 and/or the memory structures 54 may be maintained in an Internet-based computing environment 61 such that the server 52 may deploy integrated publication management software as a service over the Internet. In this regard, each of the clients 56₁₋ₙ may access the hosted hardware and software resources of the publication management system 50 through a graphical user interface 58 that is accessible through an Internet browser at each of the clients 56₁₋ₙ . In this embodiment, the hardware and software may be maintained by a remote service provider. In another embodiment, the healthcare entity 100 may maintain the server 52 and/or the memory structures 54 locally.

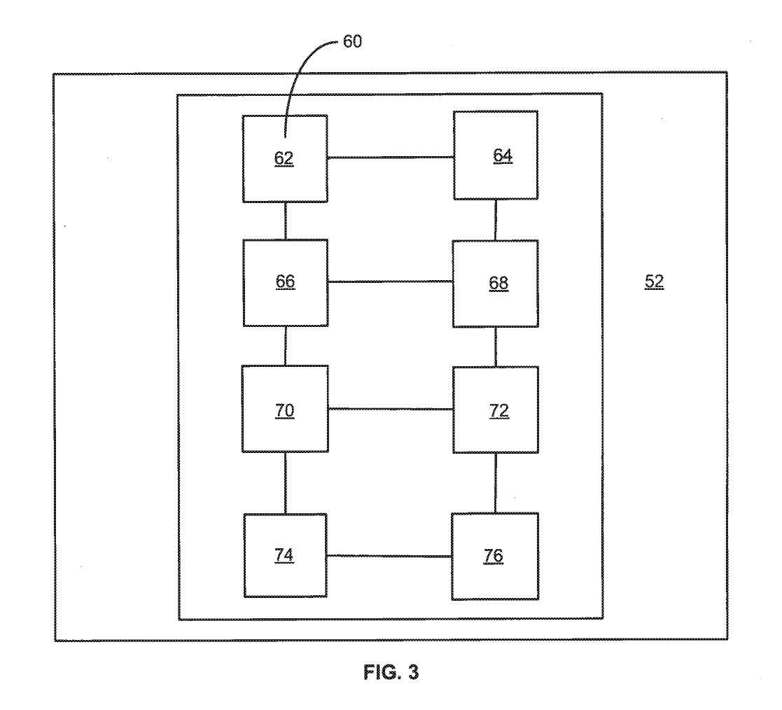

The server 52 may have one or more processors 60 that include numerous logic blocks or modules, each configured to implement a set of features or capabilities, as described below. In one embodiment shown in FIG. 3, the processor 60 may include an administration module 62, a project workflow management module 64, a reporting and metrics module 66, a rules management module 68, an assets module 70, a templates module 72, a production staging module 74, and an inventory module 76. Throughout this discussion, the terms logic block, logic, functional block, and/or module are used to describe one or more logical elements that may be distributed throughout the system 50 and that may be implemented within hardware, software, firmware, or any combination thereof. Further, while the functionality of the publication management system 50 is described as a series of discrete but interconnected logic blocks or modules, it should be understood that the system functionality may be implemented in any appropriate manner using any appropriate combination and/or distribution of hardware, software, and/or firmware.

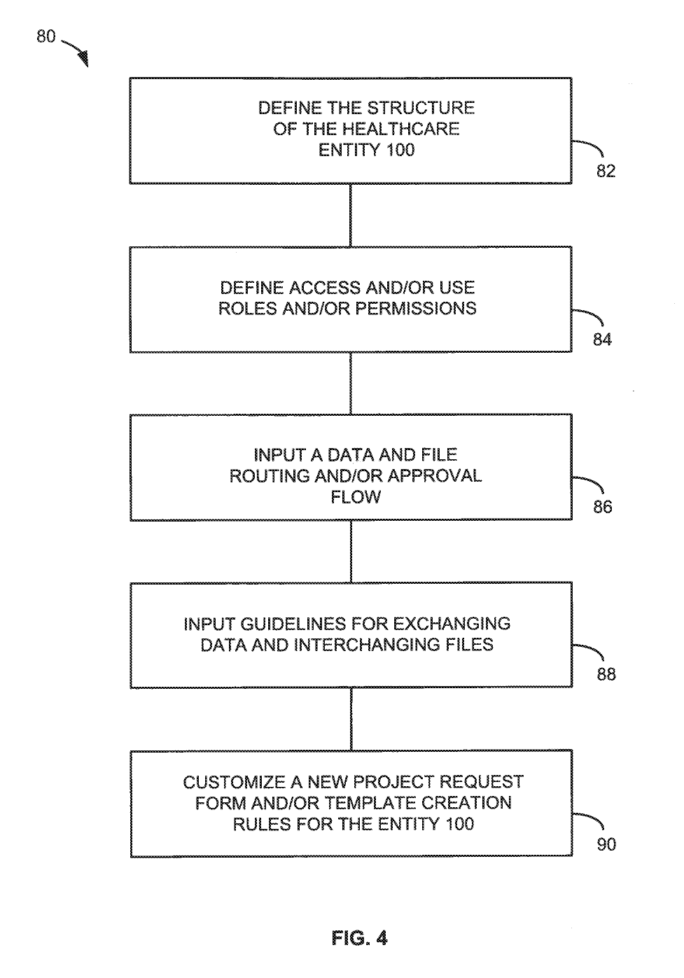

The administration module 62 may control an implementation or registration process to setup and qualify the healthcare entity 100 or individual users or prospective users within the entity 100. In this regard, personnel within the entity 100 or an external service provider responsible for providing and maintaining the publication management system 50 may interact with the system 50 through the graphical user interface 58 to customize the system 50 for use within the healthcare entity 100. FIG. 4 illustrates an exemplary implementation protocol 80 for execution in relation to the healthcare entity 100. In this embodiment, the exemplary implementation protocol 80 begins with defining the structure of the entity 100 (82), including defining one or more service groups and/or individual users within the service groups along with a corresponding organizational hierarchy and managerial chain. The protocol 80 may continue with defining access and/or use roles and permissions (84). The access and use roles and permissions may be organized in any appropriate manner suitable for the entity 100. For example, the roles and permissions may be based on each individual contributor or they may be service-group based. In one embodiment, rules may include a traffic manager, compliance personnel, systems users, and an a system administrator.

The implementation protocol 80 may also involve inputting a data and file routing and/or approval flow for the entity 100 (86) as well as guidelines for exchanging data and interchanging files within the system 50 (88). Based on several characteristics of the entity 100, the implementation protocol 80 may involve customizing a new project request form and/or defining a number of rules that govern template selection, version generation, and document customization (90), all discussed below, to reflect entity terminology, hierarchy, policy, and/or any other appropriate business practices or characteristics of the entity 100 (e.g., customize drop down menus, selection titles, etc.). Notably, the steps 82-90 of the implementation protocol 80 may occur in any appropriate order. Moreover, one or more of the steps may be excluded when appropriate, and skilled artisans will recognize that the protocol 80 may include any additional steps that are necessary and appropriate to customize the system 50 for use within the exemplary healthcare entity 100.

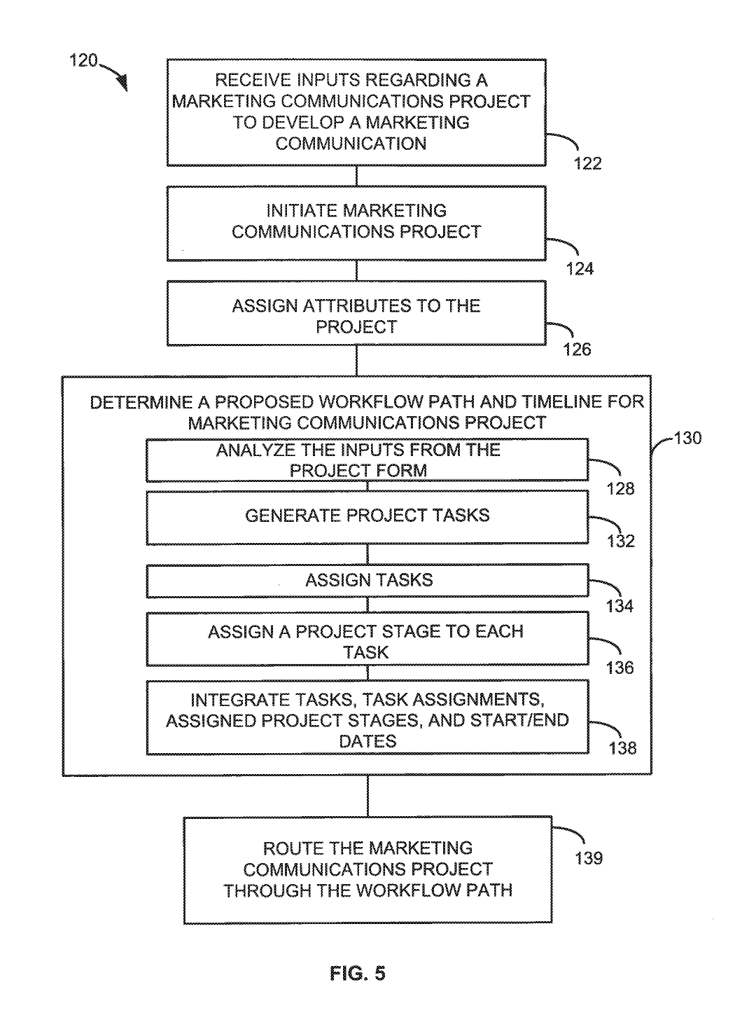

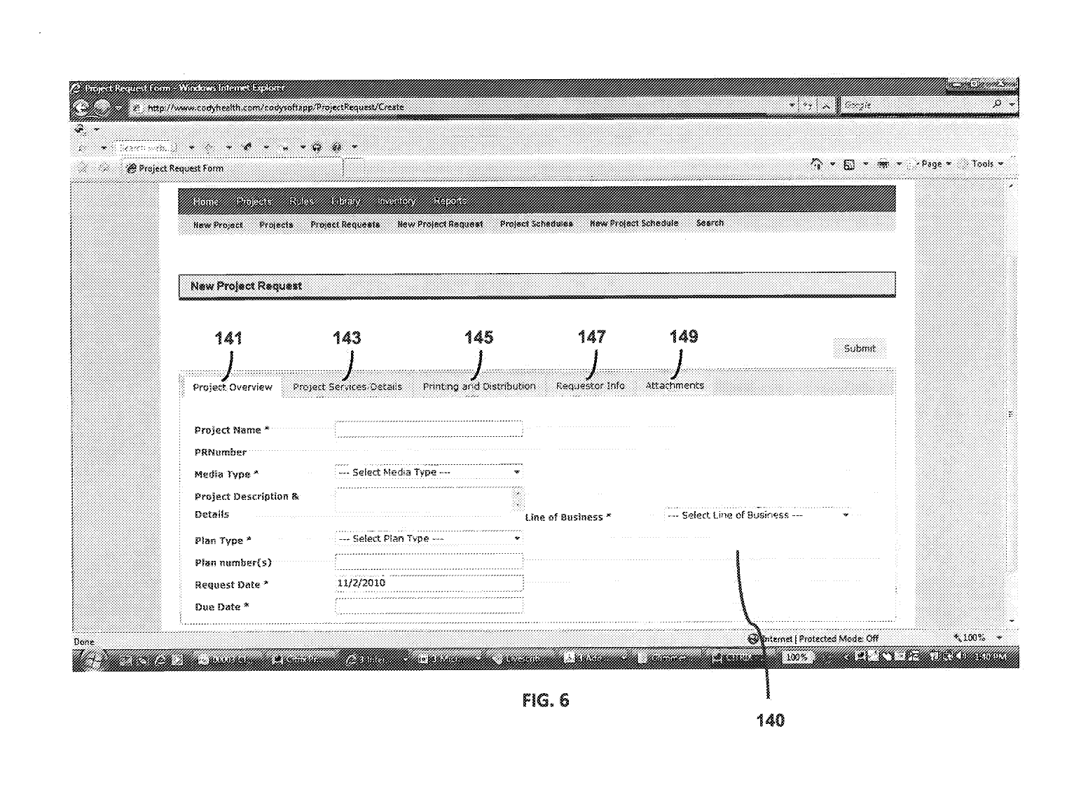

The project workflow management module 64 (FIG. 3) may control the receipt of information required to initiate a new marketing communications project as well as determine and manage a workflow, timeline, and associated tasks for the project. In this regard, the workflow module 64 may interact with several of the other modules 62, 66-76 that are directly involved in carrying out one or more of the tasks to be completed. FIG. 5 illustrates an exemplary workflow management protocol 120. In this embodiment, the workflow management protocol 120 may begin with receiving, through the graphical interface 58 (FIG. 2), inputs regarding a marketing communications project to generate a desired marketing communication (122). To that end, FIGS. 6-11 show screenshots of one embodiment of a new project request form 140 that is accessible through the graphical user interface 58. The new project request form 140 may include four tabs that allow the user to access different areas of the form. FIG. 6 details a first tab, or a project overview tab 141. Through the project overview tab 141, the user may provide several inputs that define the desired marketing communication. These inputs include a project name, project number, project description and details, as well as line of business, plan type, and plan number(s) to which the project pertains. The user may also specify a media type, a request date, and a project due date.

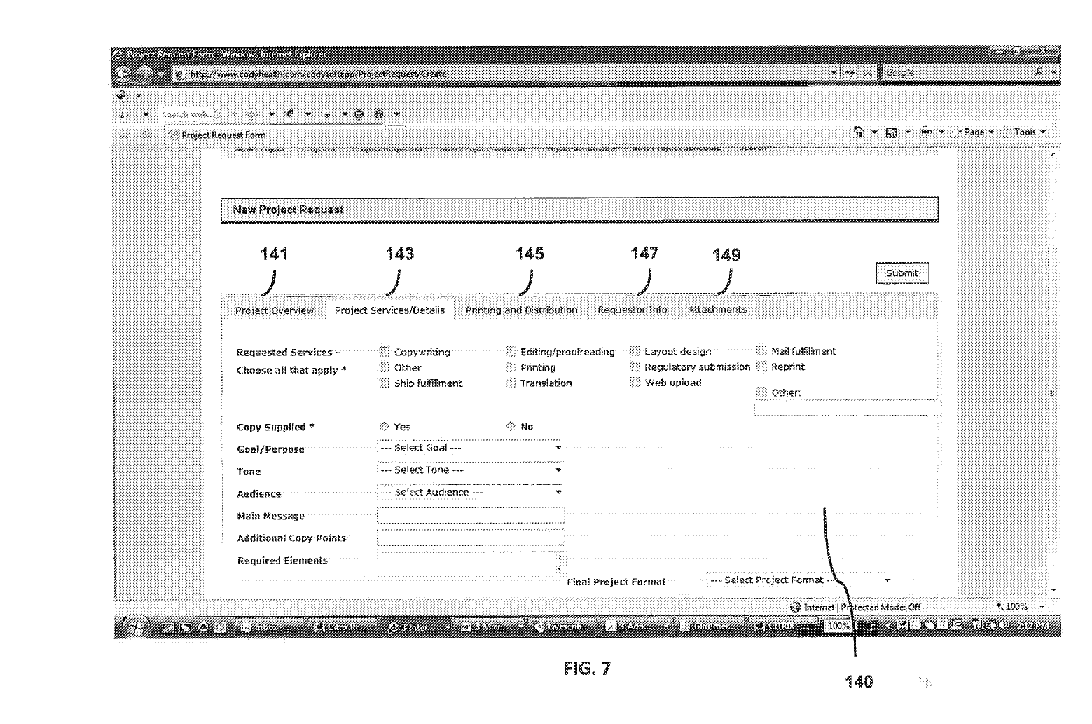

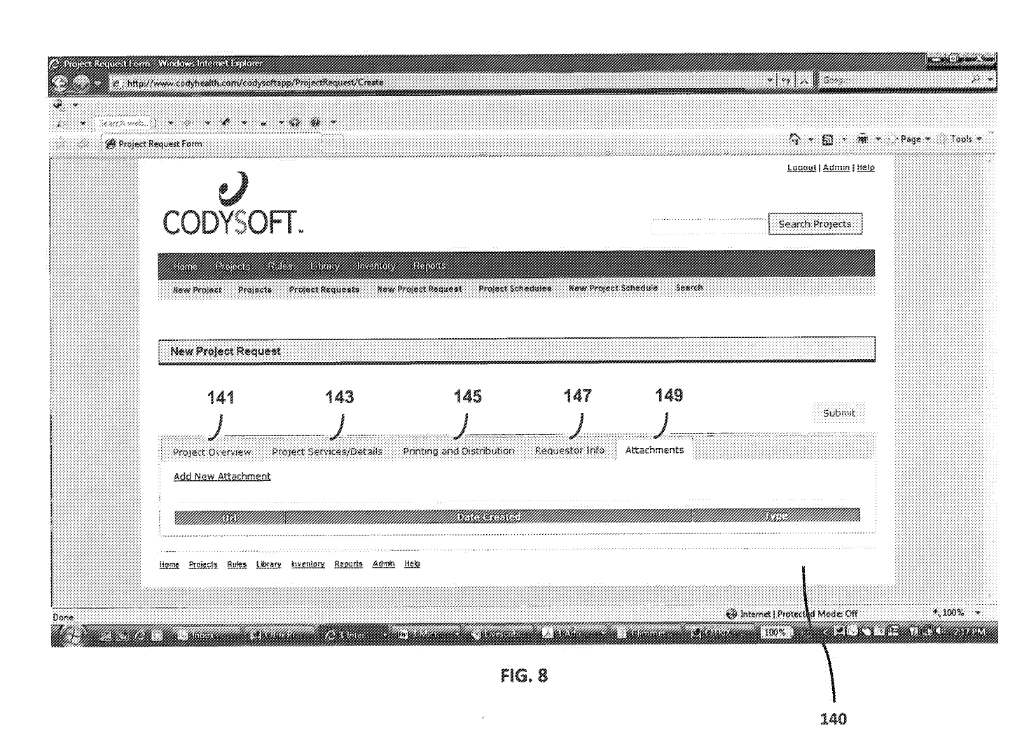

To provide guidance in developing a workflow and tasks for completion, a project services/details tab 143, shown in FIG. 7, allows the requesting user to specify the types of services that will be necessary to complete the project. For example, in this embodiment, the user may select from among several publication-related services including copywriting, editing/proofreading, layout design, regulatory submission, translation, reprint, printing, mail fulfillment, ship fulfillment, web upload, and other services specifically defined by the requesting user. The user may also define the audience to receive the communication and explain the goal or purpose of the marketing communication and an appropriate tone for the communication. Beyond these criteria, the user may specify a final project format such as, for instance, CD, DVD, Excel spreadsheet, PDF, Word document, and/or hard copy. The user may also stipulate a custom message, copy points, and stipulate any required elements of the marketing communication. Moreover, the user may indicate that custom copy is supplied with the request before uploading the copy through an attachments tab 149, shown in FIG. 8. The user may also use the attachments tab 149 to upload a template to be used in developing the marketing communication.

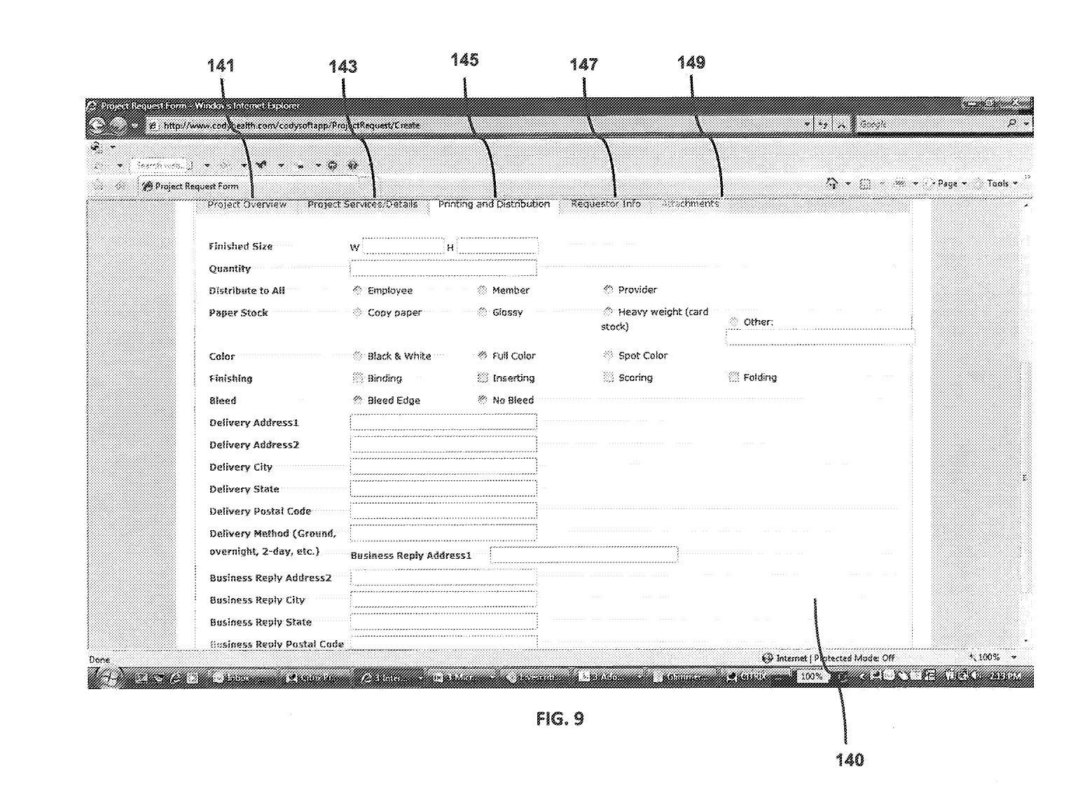

Through a printing and distribution tab 145 shown in FIG. 9, the user may specify an array of printing and/or production details regarding the desired quantity, size, color, and finish of the marketing communication. The user may also provide details relating to the delivery method for the finished marketing communication, including a delivery method or methods and delivery destinations.

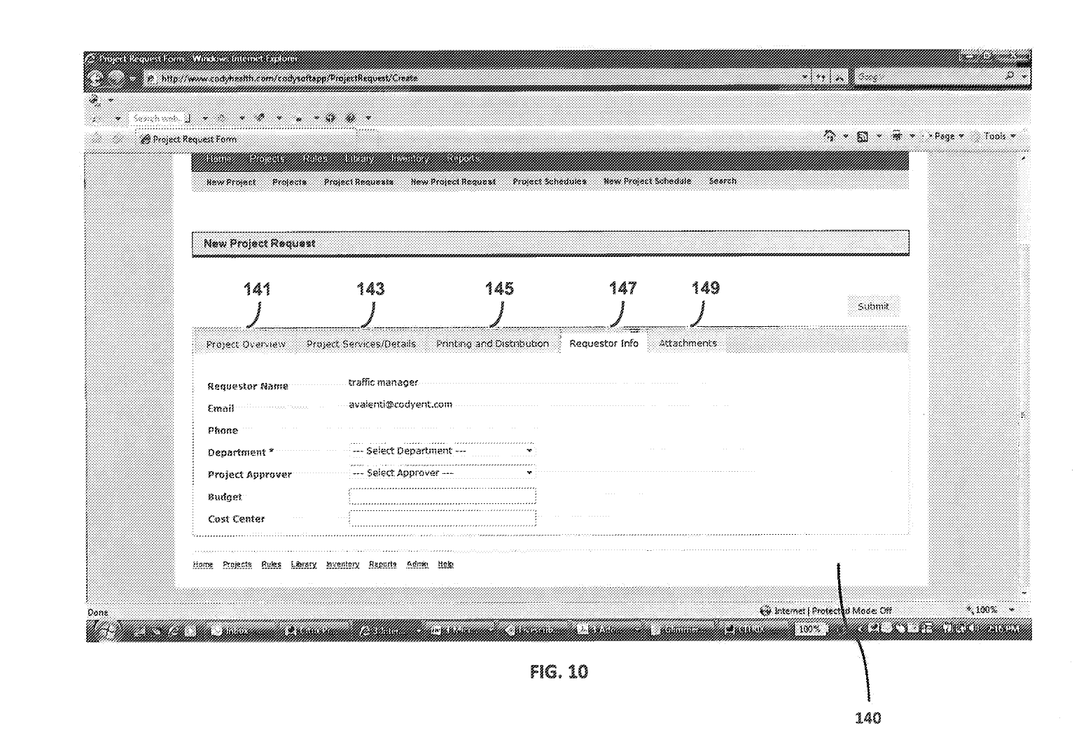

Through a requester info tag 147 shown in FIG. 10, the requesting user may provide his or her name, email, and department. The requester may also provide guidance regarding a chain of managerial or other project approvals as well as budgetary constraints and/or guidelines for the project.

While FIGS. 6-11 show one embodiment of the new project request form 140, it should be noted that the new project request form may include any relevant and/or desirable inputs. For example, in another embodiment, the request form 140 may include several inputs related to a regulatory compliance review, including the regulatory body that must review the marketing communication and pertinent details relating to that review.

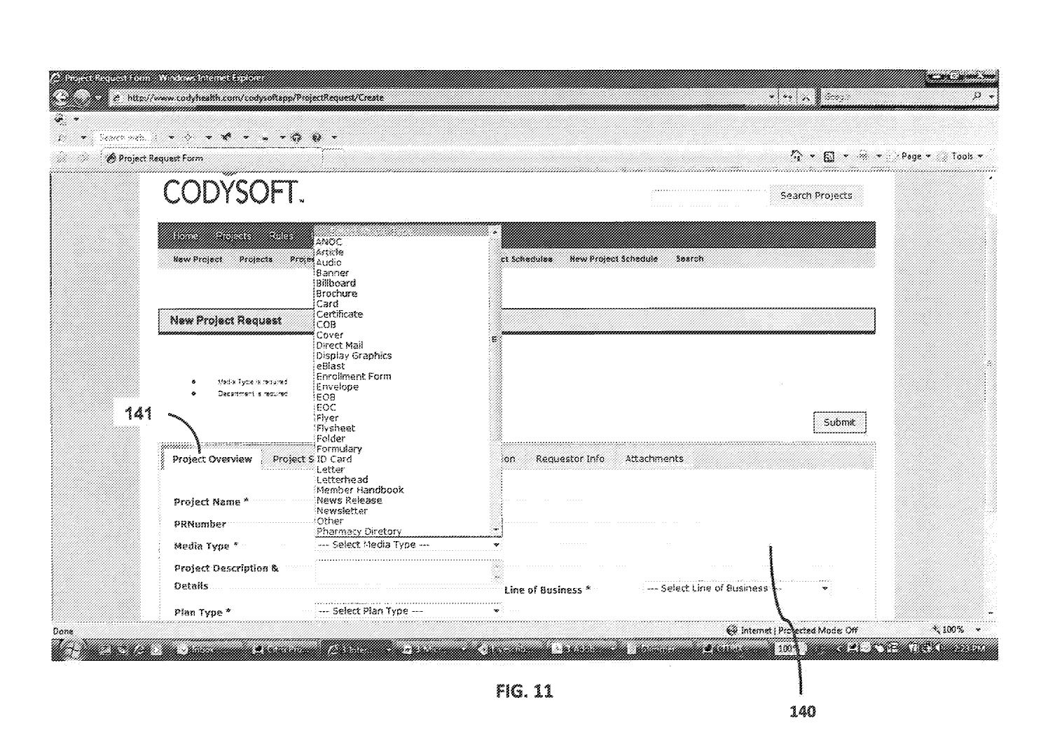

To simplify the user's experience in providing the inputs, one or more of the input categories may be associated with drop-down a menu. To provide a few examples, FIG. 11 shows that in this embodiment, the “media type” entered via the project overview tab 141 allows the user to define the type of communication to be developed and is associated with a drop-down menu that includes an ANOC, an article, an audio recording, a banner, a billboard, a brochure, a card, a certificate, a COB, a cover, a direct mailing, display graphics, an eBlast, an enrollment form, an envelope, and EOP, an EOC, a flyer, a flysheet, a folder, a formulary, an ID card, a letter, a letterhead, a member handbook, a newsletter, a news release, and so on. Similarly, the “department” (FIG. 10) may be associated with a drop-down menu that includes the various departments within the healthcare entity 100, including, for example. administration, business development, marketing, compliance, creative services, enrollment, finance, HR, IT, legal/general counsel, Medicare, Medicaid, member services, provider operations, quality assurance, sales, training, utilization management, wellness, or other. The “goal/purpose” input (FIG. 7) may be associated with a drop-down menu including, for example, cross selling, employee notification, government required member information, increased brand awareness, increased enrollment, increased sales leads, member notification, and so on. And the “tone” input (FIG. 7) may be associated with a drop-down menu that includes, for example, casual, fun, informative, motivational, professional, regulatory, and the like.

Notably, and as discussed above, the project request form 140 may be customized (90) as part of the implementation protocol 80 (FIG. 4). In this regard, the project request form 140 becomes a reflection of the customer entity (i.e., the particular healthcare entity that is employing the system 50) and its particular business. For example, different entities may have different departments, varying managerial hierarchies for approval, and different terminologies and acronyms that are used to describe available services, plan types, media types, and so on.

The project request form 140 may also be designed such that the marketing communications project as well as the documents associated with the project are indexed and saved according to a naming convention that meets the requirements of the relevant governing body (e.g., CMS). That is, organizations like CMS generally require several elements of information to be provided along with any marketing communications approval request (e.g., a CMS contract number). The project request form 140 may be configured to receive this information and incorporate it into either or both of the project title and the file names of associated documents. Beyond increasing the likelihood that all required information will be provided to the relevant regulatory body, this file and project-naming approach also ensures that all of the service groups 101-110 will employ the consistent naming conventions mandated by the computerized system 50. Traditionally, some service groups, such as the compliance group 104, have operated separately from and without a great deal of communication with the other service groups. This results in problems in accurately tracking compliance reviews and keeping marketing communications projects on schedule.

Conventional processes employed in developing healthcare marketing communications often involve paper request forms that must be manually submitted to a traffic manager for approval, scheduling, and management. As a result, project requestors often ignore one or more of the inputs listed on the paper project request form, which slows the approval process and requires additional follow-up information to be provided upon request. To address this problem, the project request form 140 may not be successfully submitted unless all required fields have been addressed. As a result, the traffic manager reviewing the request will possess all of the necessary information to make a decision with respect to the request.

Returning to the workflow management protocol 120 shown in FIG. 5, the workflow management module 64 may be used to approve and initiate a new marketing communications project based on the request form 140 (FIGS. 6-11) (124). In this regard, the traffic manager overseeing the project may review the inputs and either approve the request, reject the request, or note that the request is pending while outstanding questions and/or issues relating to the request are resolved. Once the request has been approved, the project becomes active and the workflow management module 64 and/or a traffic manager may and assign attributes to the project (e.g., start date, due date, media type) (126) and analyze the inputs from the project request form 140 (128) to determine a proposed workflow path and timeline for developing the desired marketing communication (130) (i.e., generating, approving, producing, and delivering the desired marketing communication). In this regard, the traffic manager and/or the workflow management module 64 may, based upon the inputs to the project request form 140, generate a number of tasks to be completed over the course of the marketing communications project (132) and assign the tasks to system users and/or service groups for completion (134).

In one embodiment, the tasks may be a direct result of one or more requested services. For example, if the inputs reflect a request for copywriting as well as proofing and editing, then the workflow management module 64 may incorporate corresponding tasks into the workflow path. In another implementation, one or more regulations may mandate certain tasks. For instance, if a defined statistical percentage of the intended audience is non-English speaking, federal and/or state regulations may mandate that the marketing communication be provided in the non-English speaking population's native language, and a translation task will be included into the workflow path. In this regard, applicable regulations may be incorporated or embedded within a set of guidelines or rules for selecting and/or developing the template documents and their versions such that the regulations are automatically accounted for in developing the requisite tasks, and thus the workflow path and timeline, for the project. Some regulations may be embedded directly into the system software, while others may be added during the implementation process, discussed above, after the entity's compliance group 104 reviews and approves the rules.

The workflow management module 64 may also assign a project stage to each task (136). The project stages sequence the tasks into a particular order such that each project stage defines “when” a particular task is to be completed in relation to the other tasks.

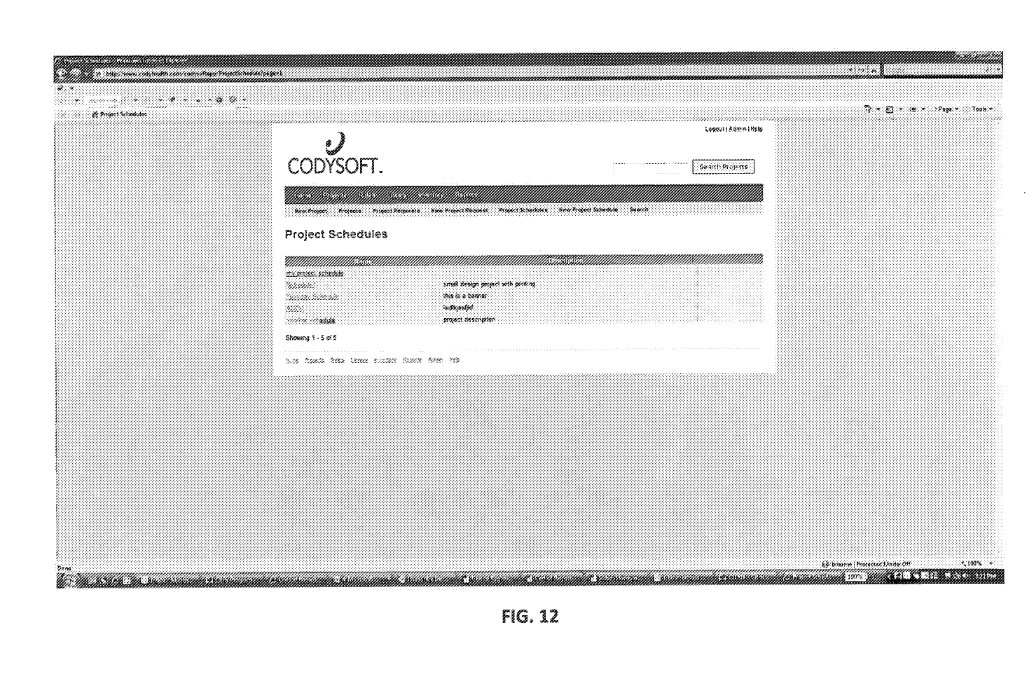

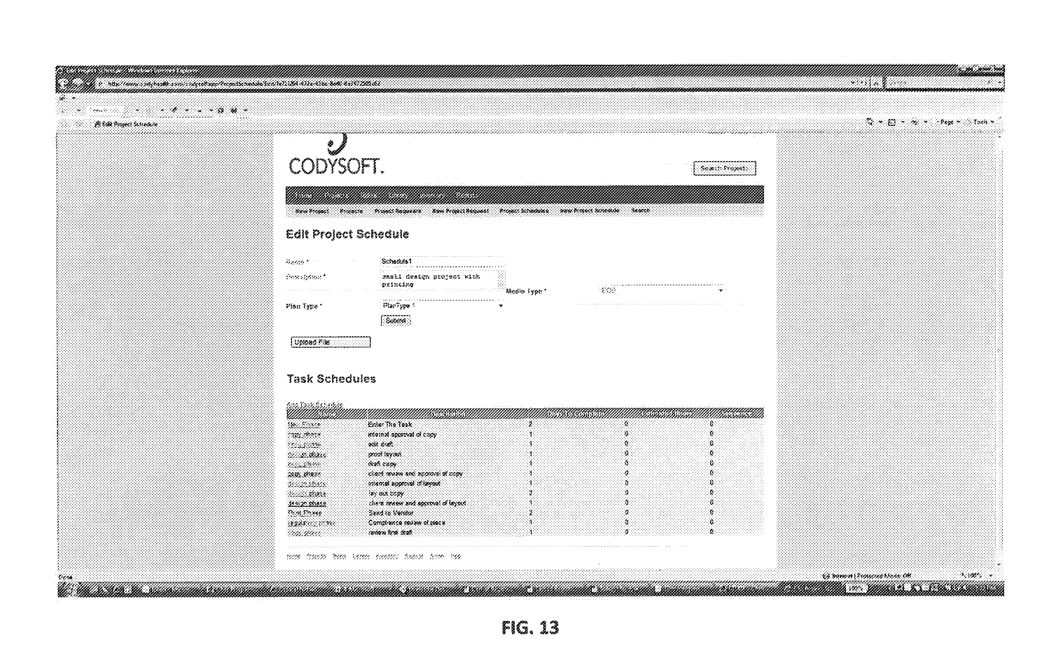

By combining the user or group assigned to each task, the project stage assigned to each task, and the start and end dates of the project, the workflow management module 64 may generate the project workflow path and the timeline (138). The project workflow path sets forth the progression of the marketing communications project through applicable ones of the service groups 101-110 of the healthcare entity 100, and if applicable, through any appropriate external entities such as, for example, one or more regulatory bodies that must approve the marketing communication. To demonstrate, FIG. 12 shows a variety of project schedules or workflows that are accessible through the graphical user interface 58 of the system 50. In this particular instance, five marketing communications projects are ongoing within the healthcare entity 100. The user may click on any one of the available schedules to review the project tasks and workflow. For example, by clicking on the project entitled “Schedule1,” shown in FIG. 12, the user may view the tasks associated with the “Schedule1” project, as well as each task's projected time for completion (e.g., days and/or hours) and sequencing, as shown in FIG. 13. This particular “Schedule1” project includes thirteen tasks including “internal approval of copy,” “edit draft,” “proof layout,” “draft copy,” “client review and approval of copy,” “internal approval of layout,” “lay out copy,” “client review and approval of layout,” “send to vendor,” “compliance review of piece,” and “review first draft.” Each of these tasks may be assigned to a user and/or service group and may be associated with a number of days and/or hours to complete and an ordering sequence. In one embodiment, each item of information may appear on the schedule as an editable link such that a user with the appropriate permissions may conveniently access and edit schedule information (e.g., move tasks, change tasks, close or delete tasks).

Once the workflow path and timeline have been established, and in some embodiments reviewed and approved by a traffic manager to ensure their viability, the workflow management module 64 may route or marshal the marketing communications project through the workflow path (139). That is, the workflow management module 64 may inform users of the initiation of the project and alert users within the service groups 101-110 as their assigned tasks become ripe for completion. Such notification may be made through email notifications or via access to the system 50 via the user interface 58. If, during the progress of the project, a task slips or takes additional time for completion, the workflow module 64 may cascade the remaining tasks accordingly.

As the project progresses, the workflow module 64 may track the status of each task, including the status of any internal approvals (e.g., approval by a subject matter expert, approval by an audience champion, managerial approval) and/or external approvals (e.g., approval by a regulatory body). In one embodiment, the step of routing the marketing communications project through the workflow path may include automatically and/or electronically submitting a draft of the marketing communication to one or more regulatory bodies (e.g., CMS) for approval.

In addition, the workflow module 64 may be used to track regulatory approvals through the creation of electronic compliance records. That is, as users within the compliance group 104 submit draft marketing communications for regulatory approval, they may electronically log and track regulatory compliance information such as the type of regulatory approval required, the date of submission, approval status, and so on. As a result, each draft marketing communication may easily be associated with a centralized record that reflects the current compliance status of the communication. Traditionally, the compliance group 104 operates in a somewhat insulated environment within a healthcare entity, which makes it inconvenient and/or inefficient for other users assigned to a project to track compliance status. In this regard, the computerized system 50 enables a centralized and visible mechanism for the entire project team, regardless of service group, to report upon and review the project's status.

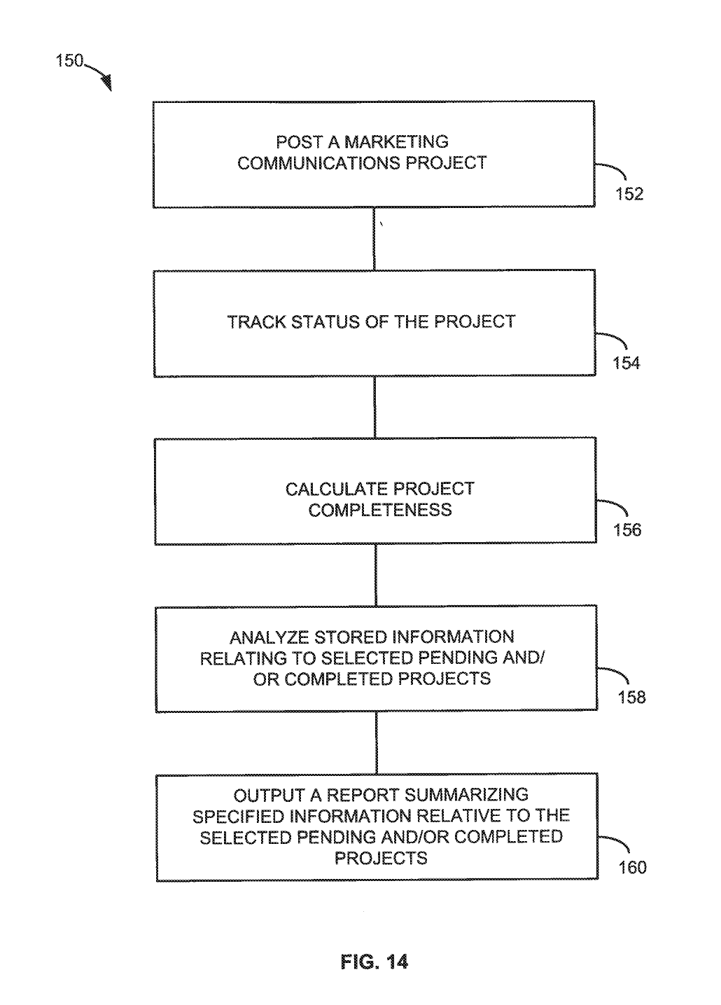

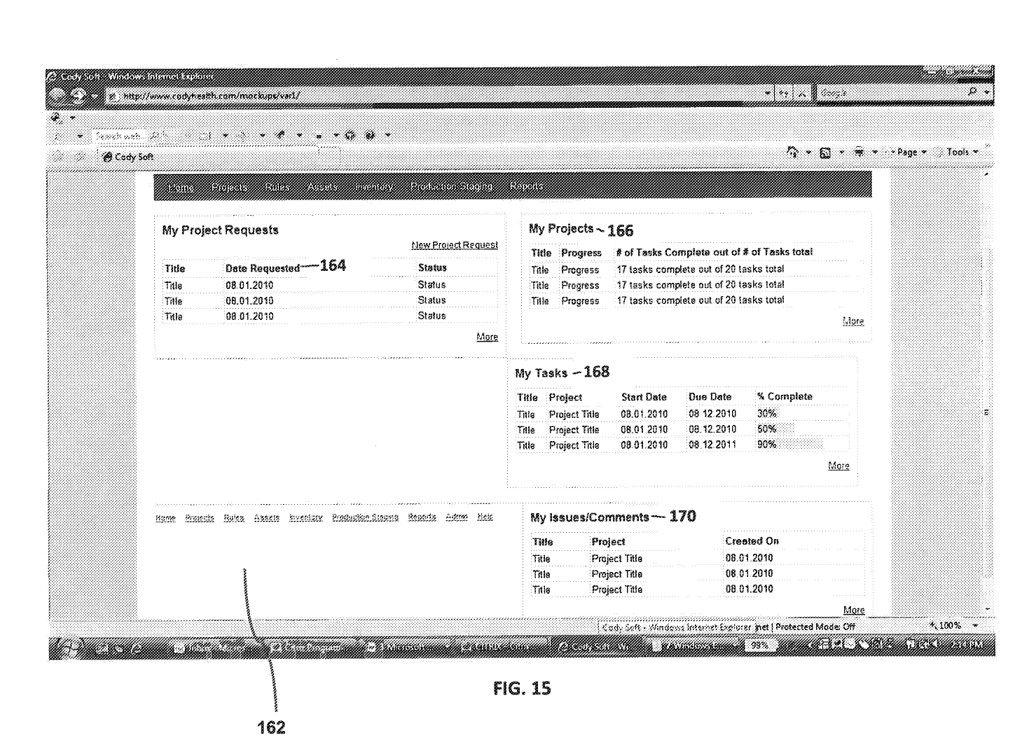

The reporting and metrics module 66 outputs status information relating to the project through the graphical user interface 58. To that end, FIG. 14 shows an exemplary reporting and metrics protocol 150. The protocol 150 begins with posting a marketing communications project for viewing through the graphical user interface 58 (152). For example, FIG. 15 shows a screenshot of one embodiment of a homepage 162 of the graphical user interface 58. In this implementation, the homepage 162 shows links to four categories of information, including a “My Project Requests” link 164, a “My Projects” link 166, a “My Tasks” link 168, and a “My issues/Comments” link 170. Using these links, a user may view projects that he or she has personally submitted as well as any projects having tasks to which the user has been assigned. As users within one or more of the service groups 101-110 progress through their assigned tasks, the reporting and metrics module 66 may track the progress of the project (154) (FIG. 12). By comparing the remaining tasks to be completed against the tasks that have been completed, the module 66 may calculate a percentage of completeness of the project in real-time (156). To facilitate communication between users, both within individual ones of the service groups 101-110 and across the service groups 101-110, users may input problems or issues that arise as they complete their assigned tasks through the “My Issues/Comments” link 170 of the graphical user interface 58. This feature allows problems, questions, comments, and the like to be published for viewing by the entire the project team.

In addition to tracking the status of individual projects, the reporting and metrics module 66 may compute metrics relating to the cumulative project-portfolio of the healthcare entity 100. Moreover, the metrics may relate to current projects and/or past projects. In this regard, the reporting and metrics module 66 may be used to generate a variety of customized reports summarizing statistics, metrics, and/or trending seen in the marketing communications projects of the healthcare entity 100. These reports may include production reports, daily task reports, workload balance reports, executive reports, and a variety of ad hoc reports upon request. For example, a report could be generated to inform management of the entity's average project budget or an average time for completion across the entity's project portfolio. In another example, a report could be generated to identify bottlenecks in the development process. That is, reports generated by the reporting and metrics module 66 may by instructive in identifying tasks that are generally pending for comparatively longer periods of time. In yet another example, a snapshot report may be generated to provide an overview of all currently pending projects within the healthcare entity 100 along with their respective statuses. Returning to the exemplary reporting and metrics protocol 150 (FIG. 14), the protocol 150 may continue with analyzing stored information relating to one or more pending and/or completed projects (158) and outputting a report summarizing specified information relative to the selected pending and/or completed projects (160).

Beyond the integrated management of marketing communications projects, the publication management system 50 may partially automate the process of generating the desired marketing communication. That is, the user may elect to use a template or model document when submitting the project request form 140. The rules management, assets, and templates modules 68, 70, 72 work together to implement a rules-based document creation scheme that allows the publication management system 50 to provide an appropriate template for each project request, and in some instances, to create a number of different document versions from each of the templates according to the inputs to the project request form 140. That is, the template may be tailored to the inputs provided in the project request form 140 and may act as the canvas upon which the marketing communication is generated.

In one embodiment, the compliance group 104 of the healthcare entity 100 may receive one or more basic templates associated with each of a number of media types that the system 50 supports (e.g., an ANOC, a letter, an eBlast, a member handbook, a postcard) from an appropriate regulatory body such as, for example, CMS. These templates may be stored in the memory 54 (FIG. 2) of the system 50 and may be loaded as an attachment to the project request form 140. Additionally or alternatively, the compliance group 104 and/or the MarCom group 102 may formulate one or more of templates, either from scratch or by modifying a foundational document received from an appropriate regulatory body.

In addition to the templates, a number of assets may be stored in the memory 54 (FIG. 2), forming a library of the system 50, detailed below. Exemplary assets include graphics, images, logos, creative content, copy content, disclaimer blocks, header blocks, footer blocks, data or crosswalk files containing, for example, payer, plan, and/or member information (e.g., CSV data files, XML schemas), and so on. For instance, a specific regulatory disclaimer may be required by law to accompany certain types of plan information. This disclaimer block may be stored as an asset and added to an appropriate template as part of the document creation process when the project request form 140 indicates that the associated plan information will be included in the marketing communication. To accomplish this association between assets and templates, each asset may be assigned to an asset class, which in turn defines certain variables within the templates and allows the assets and/or templates modules 70, 72 to filter through the assets for document creation based on the project request form 140.

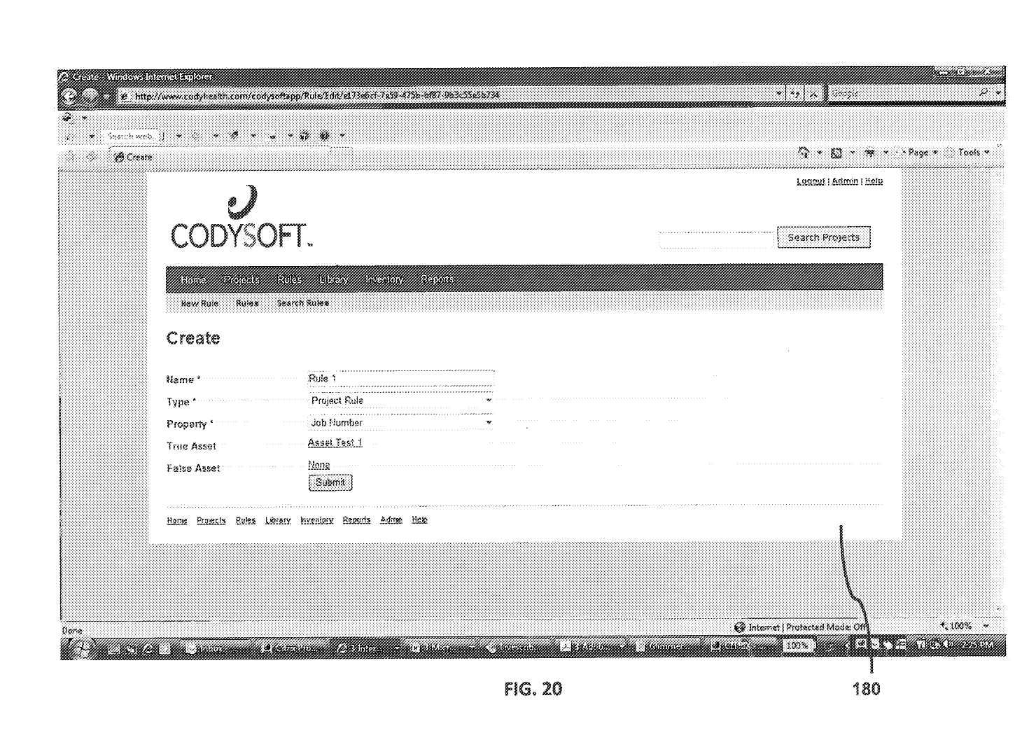

As discussed above, the templates and versions are rule-based. In this regard, the rules management module 68 may facilitate the creation and modification of rules that apply to insert one or more assets into the template based on the inputs to the project request form 140. In one embodiment, the rules are created using a rules wizard that allows for step-by-step rule definition. In this regard, the rules may be defined during the implementation process as part of the implementation protocol 80 (FIG. 4). For example, FIG. 20 shows one embodiment of a rules wizard 180 available through the user interface 58 (FIG. 2). The rules wizard allows a user, either in the normal course of operating the system 50 or during the implementation phase, discussed above, to define the rules that govern version creation and/or selection.

More specifically, each rule may define two parameters. First, each rule may point to a particular asset stored within the library of the system 50 for insertion into the applicable template. For example, a first rule may point to a data crosswalk file comprising a CSV file of stored co-pay information for various defined benefit plans. In another example, a second rule may point to a logo for a particular benefit plan. Second, each rule may be assigned one or more properties that limit or outline the application of the rule. For example, the first rule, discussed above, may include a property that limits the rule's application to a specific media type, or an ANOC. In this regard, the first rule may only be inserted into an ANOC template and cannot be erroneously applied to a flyer.

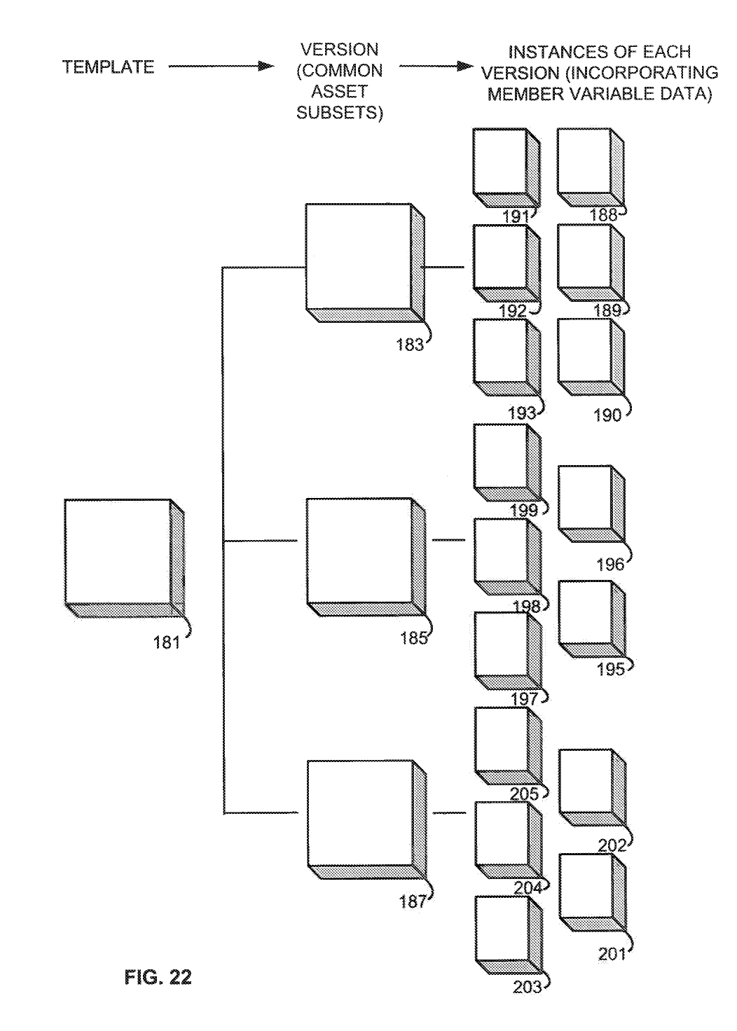

Using the rules, a template may be versioned to create a layer of customization to the template. In one embodiment, the template may be versioned based on two or more subsets of common assets. For example, a template for an ANOC may be versioned according to plan type, where each version is based upon the same template (e.g., an ANOC template) but incorporates a different common subset of assets that are associated with the same plan type. FIG. 22 graphically depicts this template versioning concept. As shown in FIG. 22, a template 181 may form the basic structure for an ANOC that has one or more assets that are common to every instance of the marketing communication. Three versions 183, 185, 187 of the template 181 may each include a subset of assets, where each subset of assets is common only to the corresponding version 183, 185, or 187. For example, the version 183 may incorporate assets (e.g., regulatory disclaimers, images, header blocks, footer blocks, copy) associated with a Medicare Advantage plan, and the versions 185 and 187 may incorporate assets associated with a Medicare Part D and an HMO plan, respectively.

The template and/or the template versions may, in one embodiment, serve as building blocks for generating the marketing communication and may be altered or built upon as the marketing communications project progresses through the workflow path, discussed above. For example, copywriters and editors within the MarCom group 102 may add copy and/or make editorial revisions to the template and/or versions. In another instance, one or both of a subject matter expert and an audience champion from the compliance group 104 may make or suggest changes to certain language contained within the template and/or versions. In yet another example, users from the compliance group 104 may add or modify disclaimer language in order to secure regulatory approval, or alternatively, an external regulatory body may suggest or require specific disclaimer language. Thus, the template and its versions serve as a starting point or draft of the marketing communication, but oftentimes do not represent the finalized marketing communication for ultimate delivery to the recipients.

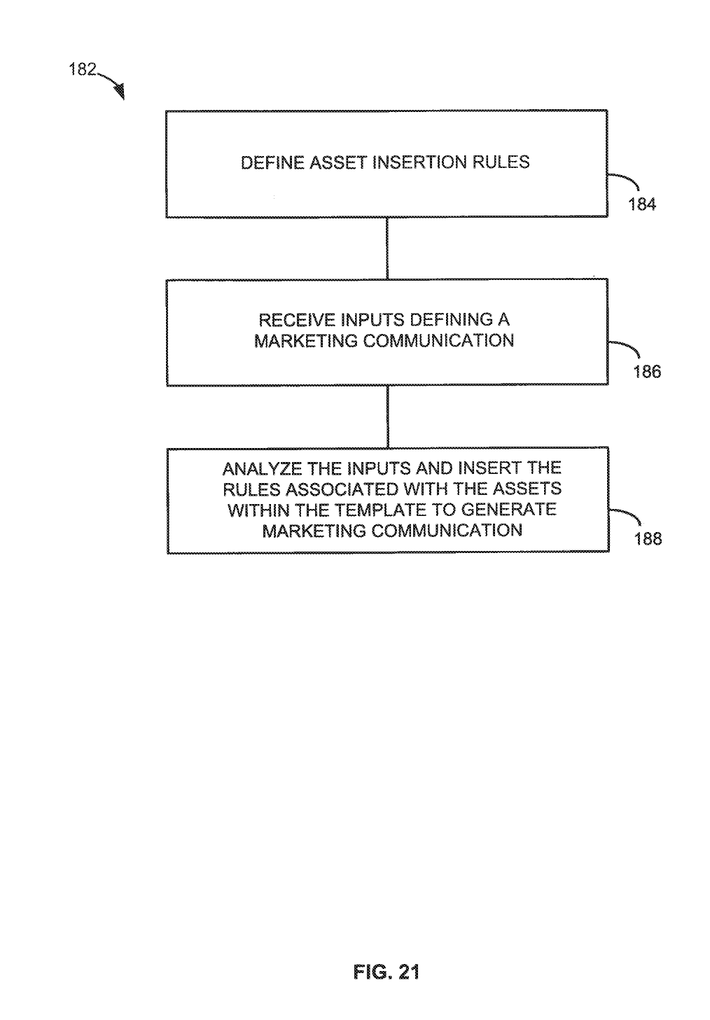

To explain how versioning may be accomplished, FIG. 21 illustrates an exemplary rules creation and application protocol 182. In this embodiment, the protocol 182 may begin with defining rules that instruct the rules management module 68 regarding the insertion of assets to populate the template using, for example, the rules wizard 180 of FIG. 20 (184). Next, the system 50 may receive multiple inputs that define a desired marketing communication through the project request form 140 (186). These inputs may include uploading a template. The rules may then be inserted into the template to associate one or more assets with the template to generate the marketing communication (188). As discussed above, these assets might include plan information blocks, data files, regulatory disclaimers, logos images, and so on. Further, different subsets of assets, and therefore different rules, may be separately inserted into a single template to form numerous versions of a template.

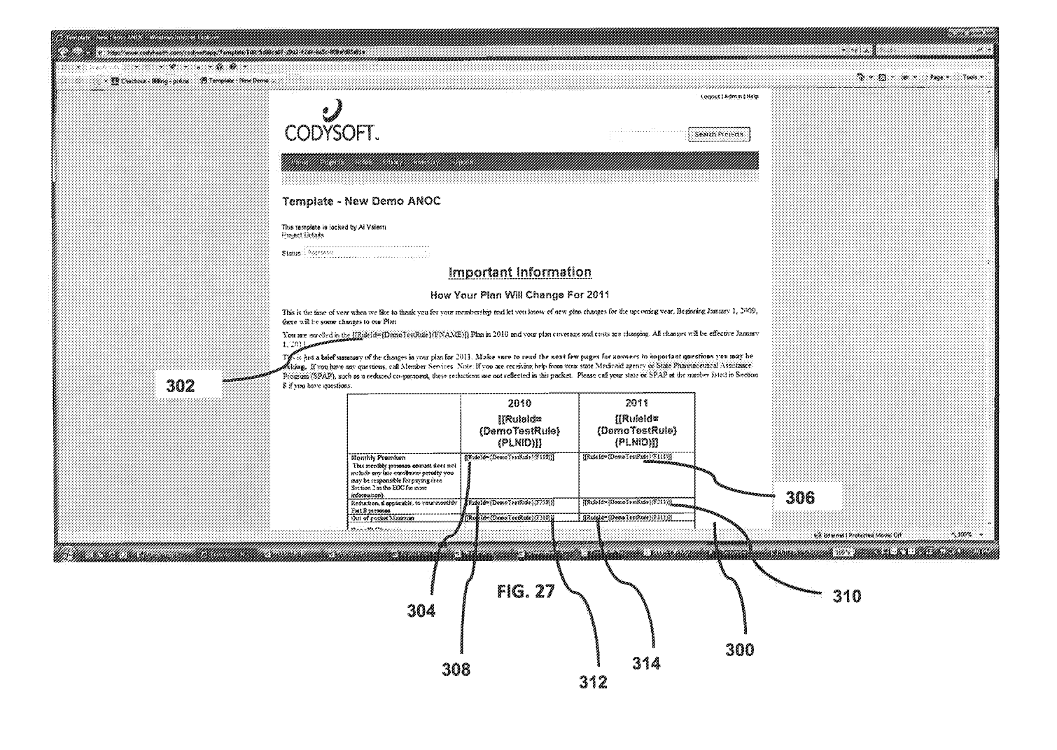

To demonstrate the versioning concept, the project request form 140 may specify an ANOC for several plan types, including Medicare Advantage as well as Medicare Part D and an HMO plan. Using this information, the publication management system 50 may select, or the requesting user may upload, an appropriate ANOC template. FIG. 27 shows an exemplary ANOC template 300 as loaded into the system 50. As shown, numerous rule insertion opportunities 302-314 exist within the template 300. Each rule insertion opportunity 302-314 allows the user to insert or stipulate a rule that points to a particular asset. In addition, each rule insertion opportunity 302-314 allows the user to stipulate or map to a particular variable within the asset to which the rule points.

For example, each of the rule insertion opportunities 302-314 of the template 300 identify the rule “DemoTestRule,” which points to a data file asset containing plan information related to the Medicare Advantage 2010 plan. Further, each of the rule insertion opportunities 302-314 are mapped to different variables stored within the applicable data file. For example, throughout the template 300, the rule insertion opportunities 302-314 map to variables FNAME, F110, F211, F210, F211, F310, F311, respectively. Each of these variables corresponds to a variable set forth within the Medicare Advantage 2010 data file to which the rule “DemoTestRule” points.

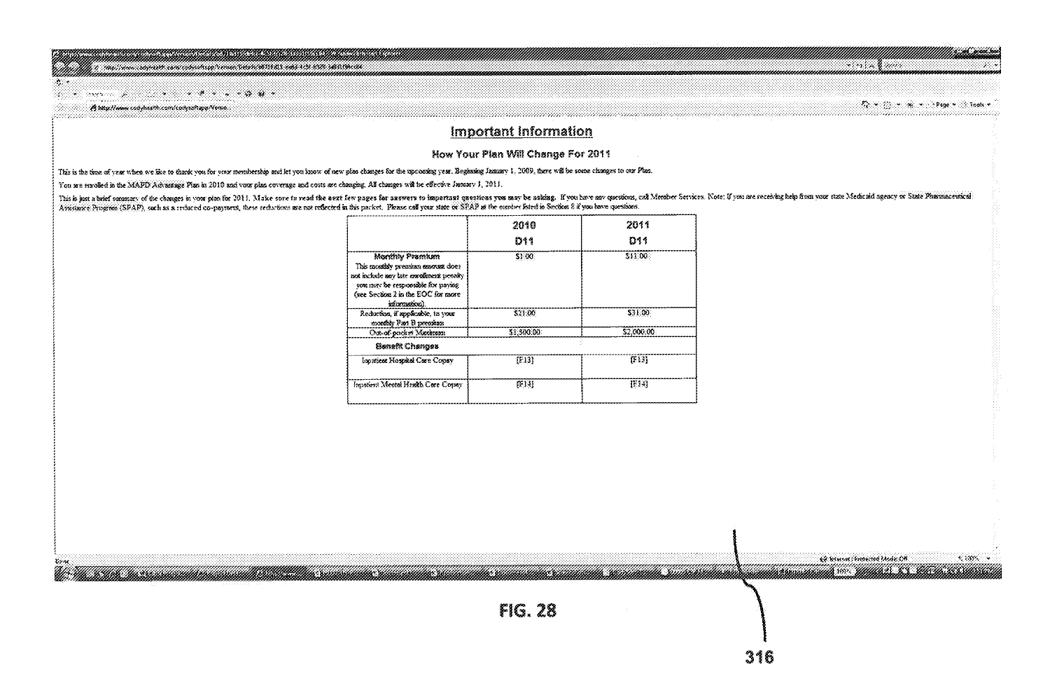

When prompted, the system 50 maps the appropriate variables from the Medicare Advantage 2010 data file to the rule insertion opportunities 302-314 within the template 300 to form a first ANOC version 316 that is customized for the Medicare Advantage plan, as shown in FIG. 28. In this regard, the system 50 may be used to create multiple versions of a template document with a few clicks of a button. For instance, the template 300 could also be versioned for the Medicare Part D and HMO plans as well. This level of customization has typically been implemented manually, costing thousands of dollars in man-hours to create multiple versions of a document.

Returning to FIG. 22, while the versions 183, 185, 187 each include elements of fixed content, or assets that are relevant to and included within all instances of the marketing communication produced from a particular template or a particular template version, additional items of custom content may vary from instance to instance of the marketing communication to render each instance of the marketing communication a truly custom communication. For example, member variable data such as member names, member addresses, member co-pays, and the like may be tailored for each instance or copy of the marketing communication. Similarly, provider network information may vary from instance to instance of the marketing communication. As a result, and as shown in FIG. 22, numerous customized instances 188-191, 195-199, and 201-205 may be produced from the template versions 183, 185, and 187, respectively.

The customized instances 188-205 of the marketing communication may be generated using mechanisms like those used to create the template versions, discussed above. That is, each instance of the marketing communication may be tokenized, or a placeholder may be located within the instance of the marketing communication at each position to receive custom or member variable information. In one embodiment, the tokens or placeholders may be placed using third-party editing software such as, for example, a WYSIWYG (what-you-see-is-what-you-get) editor.

As discussed above, a metadata repository (e.g., an XML schema, a CSV file) and a mapping structure may be developed for use in populating the items of custom content. That is, metadata reflecting the member variable data may be stored within the metadata repository, and using the mapping structure, metadata elements from the metadata repository may be indexed to corresponding ones of the token values within the marketing communication. In this regard, a number of customized instances of the prospective marketing communication can be generated by obtaining a tokenized variation of the marketing communication including a content of the template and the tokens and then replacing the tokens with corresponding items of custom content based on the metadata repository and the mapping structure. That is, mapping the metadata of the metadata repository to the tokens within the marketing communication according to the mapping structure provides an automated process for cross-walking data items or files from a table of member variable data to the marketing communication. In this regard, the member variable information may be mapped to each of the tokenized instances of the marketing communication such that the member variable information replaces the corresponding tokens to produce numerous customized instances of the marketing communication.

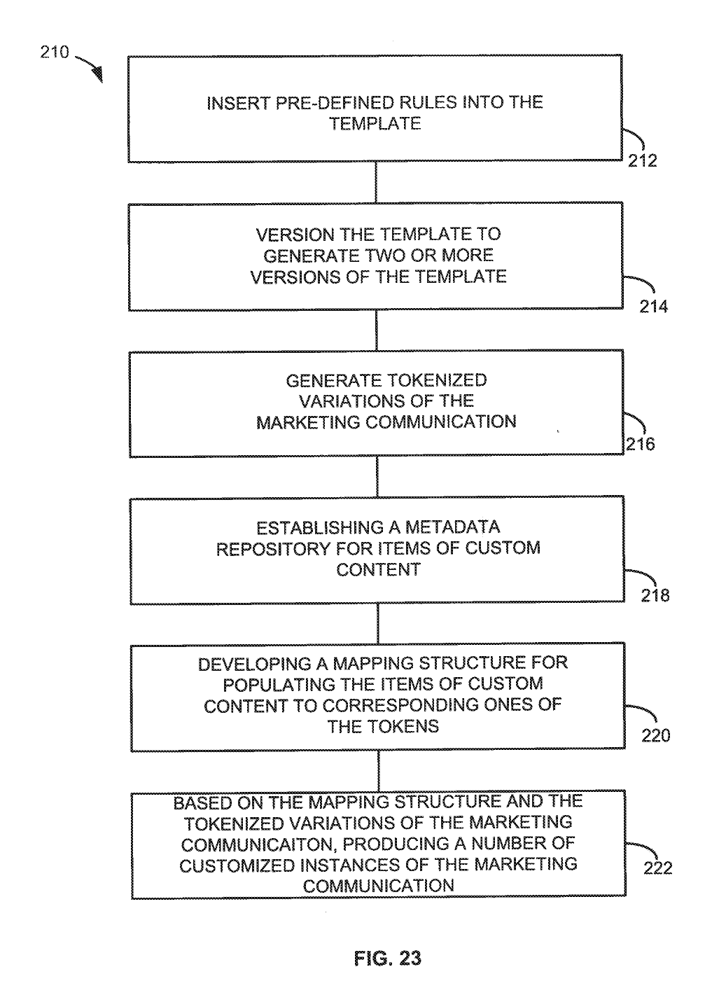

FIG. 23 illustrates one embodiment of a customization protocol 210 for producing numerous customized instances of a desired marketing communication. The protocol 210 begins with inserting one or more pre-defined rules into the document template (212) and, in one embodiment, versioning the template to generate two or more versions of the template (214), each having a subset of common assets. The protocol 210 also includes generating tokenized variations of the marketing communication (216), where each tokenized variation includes a content of the relevant template or template version and one or more tokens that generically represent items of custom content for insertion. In addition, the protocol 210 may include establishing a metadata repository for items of custom content (218) and developing a mapping structure for populating the items of custom content from the metadata repository to corresponding ones of the tokens within the tokenized variations of the marketing communication (220). Using the mapping structure, the metadata repository, and the tokenized variations of the marketing communication, the production staging management module 74 may produce a number of production pieces, or customized instances of the marketing communication (222).

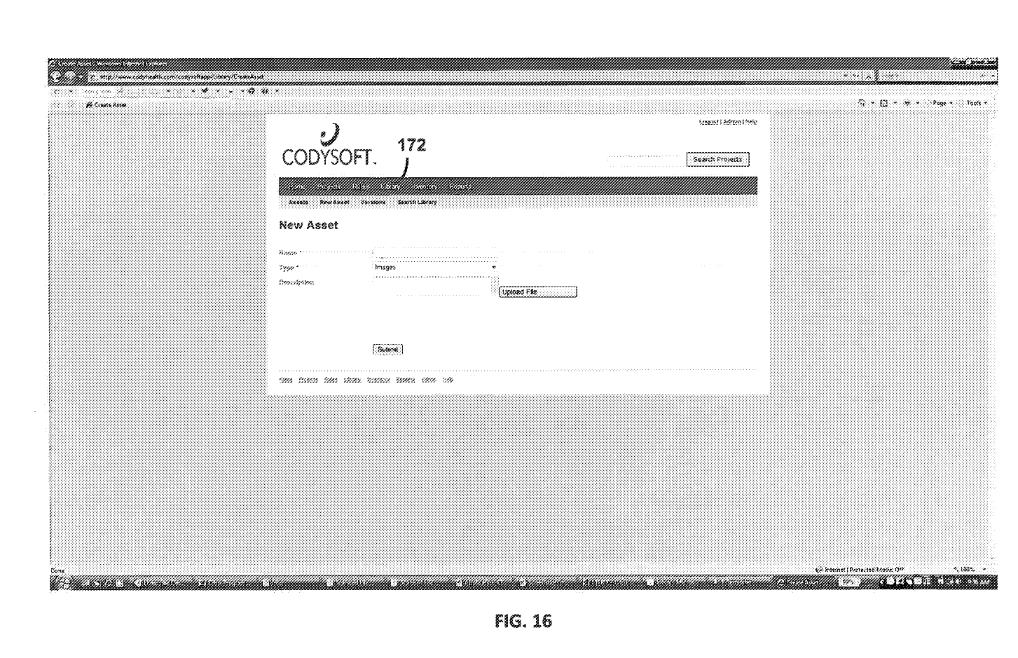

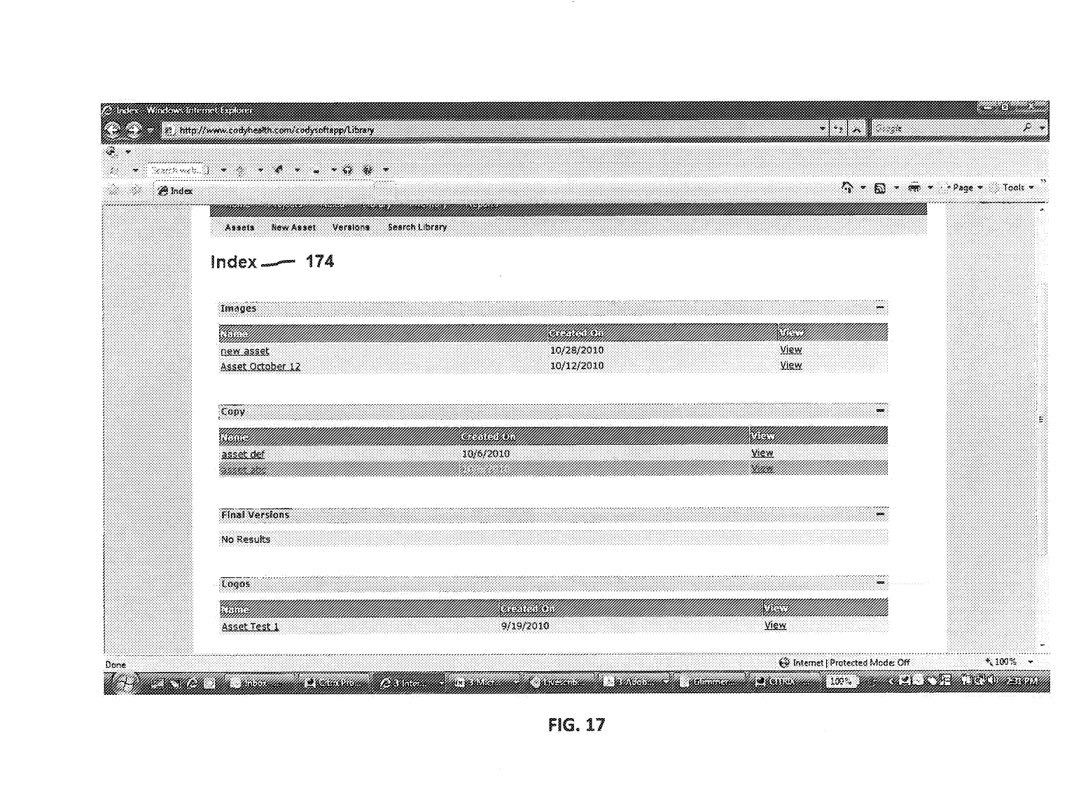

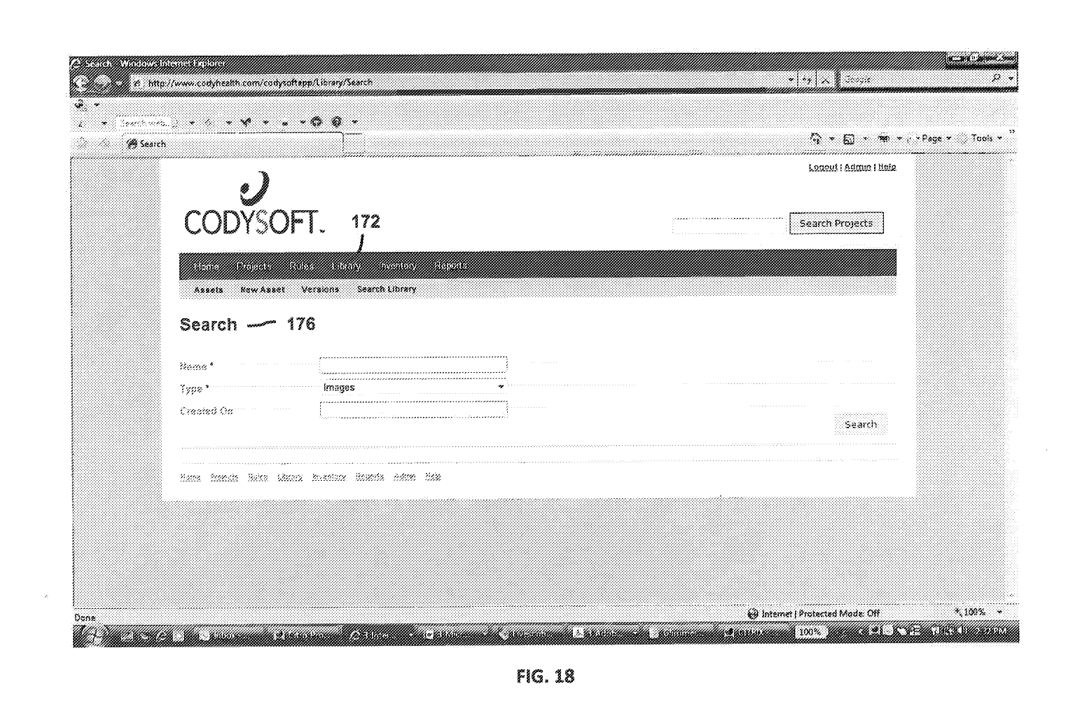

To ensure that assets and other collateral materials such as drafts and finalized electronic documents are valid and current, such materials may be uploaded, modified, deleted, and/or overwritten using the assets module 70 (FIG. 3). As a result, users may rely on the system 50 to maintain and manage an electronic library of current assets and collateral materials. FIG. 16 shows a library link 172 that is accessible through the user interface 58 (FIG. 2). Through the library link 174, users may manage an electronic library of assets and other collateral materials. For example, as shown in FIG. 16, users may upload new assets to the library through the library link 174. In so doing, users may define the asset type (e.g., image, copy, logo, data file, etc.), name, and description of the asset being loaded. When an asset is loaded, it may automatically be associated with a creation date. Users may then locate and access assets within the library through an assets index 174, shown in FIG. 17, or through a search mechanism 176 that allows users to search the library according to name, type, creation date, and so on, as shown in FIG. 18. Similarly, assets may be expunged from the library 172 or they may be indexed and archived according to type, creation date, and the like. The library 174 may be used to maintain and manage both assets and collateral materials in a similar manner.

The ability to conveniently store, organize, and access entity assets and collateral materials provides several key benefits. First, it ensures that users have access to current materials. For instance, today's healthcare industry regulations mandate that all existing marketing materials for a particular plan year expire on October 15, which signifies the beginning of the open enrollment period during which healthcare entities must roll to the next plan year's marketing materials. That is, each year, all existing assets and collateral materials become obsolete after a regulatory-defined date. Implementing the publication management system 50 to manage a current library of assets and collateral materials in which obsolete assets and collateral materials are, for example, purged from the system or archived such that they may not be incorporated into new marketing communications, assists entities in consistently and efficiently achieving regulatory compliance.

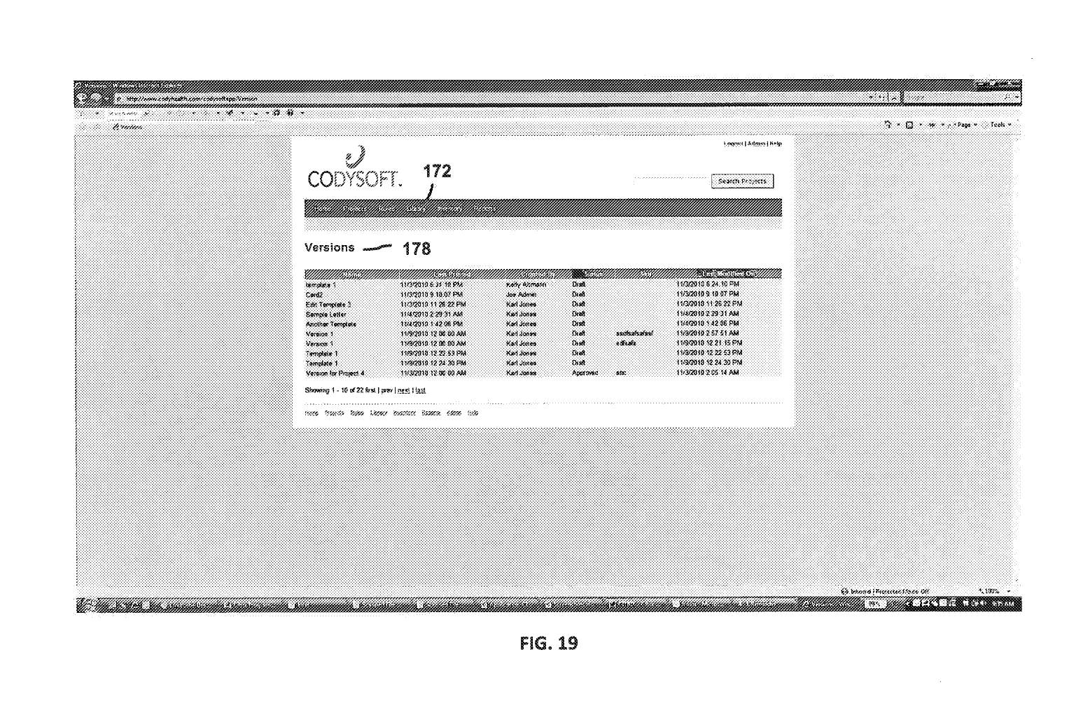

The searchable library also allows sales teams within the customer service group 110 and/or one of the product groups 101 to access desired versions of collateral materials. In this regard, users may determine whether stored collateral materials are merely drafts or whether they are approved and finalized versions of marketing communications documents that may be produced either electronically or in hard copy and delivered to recipients. For example, FIG. 19 shows a versions link 178 that is accessible through the library 172 of the user interface 58 (FIG. 2). In this example, the versions link 178 shows a variety of collateral materials that are available within the library 172, along with the date that each item of collateral material was last printed, the requesting/creating user, and the status and most recent modification date of the item of collateral material (e.g., draft, approved).

The searchable library is also critical in a regulatory audit capacity. Regulatory audits within the healthcare industry (e.g., CMS audits) often occur on short notice and require the entity to produce large volumes of requested marketing communications information. By accessing the library 172 of the publications management system 50, a healthcare entity may quickly access and provide the requested information quickly upon receiving an audit request.

Applying the techniques described above, the publication management system 50 may manage the generation, approval, and production or assembly of print ready production pieces for delivery to the recipients. Once production pieces have been produced, the production staging module 74 may provide mechanisms for review through the graphical user interface 58 prior to finalization of the marketing communication instances. The production staging module 47 may also facilitate interaction with one or more production systems through one or more application programming interfaces. In this regard, the system 50 may provide the finalized instances of the marketing communication in any appropriate production format and to any appropriate production facility (e.g., an internal print or production group, an external publishing vender). For example, in one embodiment, the system 50 may provide the tokenized variations of the template and/or template versions along with a flat text data file, a tab/space delimited file, or a CSV file that includes member variable information and/or provider network information. In this embodiment, the internal or external production facility may merge the variable information with the tokenized variations and print the finalized documents. In another embodiment, the system 50 may be used to generate PDF files containing the finalized instances of the marketing communication internally, and the PDFs may be provided to an outside vender for production or they may be printed or loaded onto a website internally.

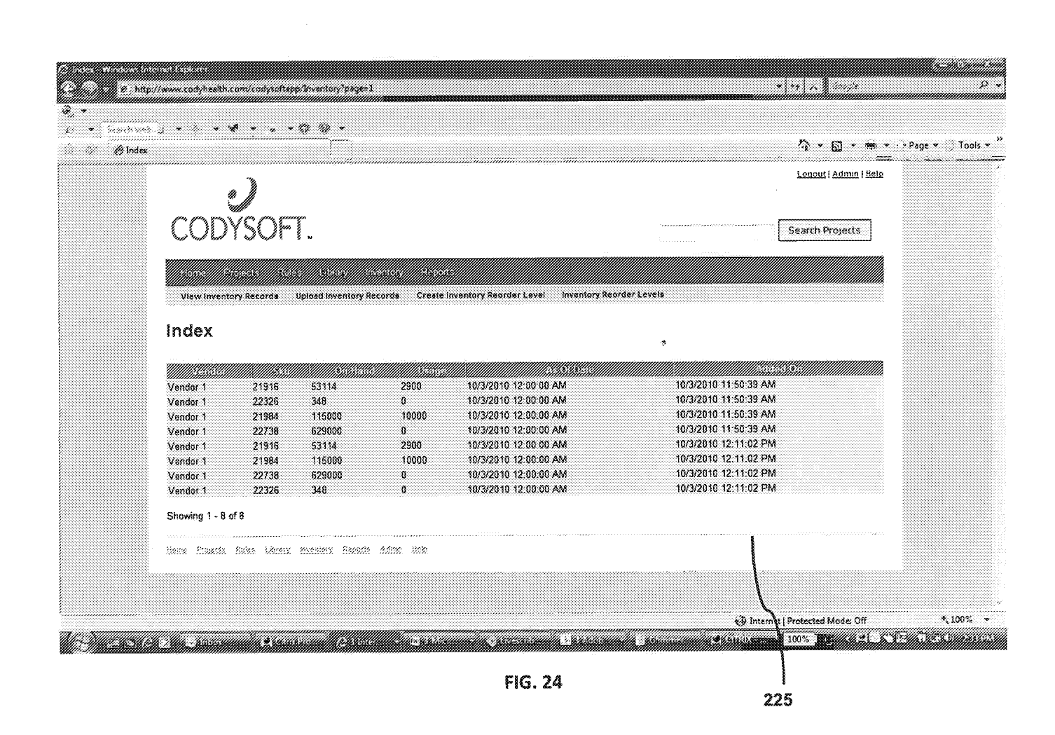

Upon completion of a marketing communications project, the production staging management module 74 may output project information to the inventory management module 76. Such project information may include completed or scheduled production dates, current production levels, current re-order levels, print vender statistics, calendar sensitivities, and so on. Using this information for each marketing communication project managed by the system 50, the inventory management module may track a variety of inventory-related parameters for the numerous marketing communications developed by the system 50. These parameters may be analyzed for use in ordering additional inventory, purging outdated inventory, planning inventory storage, planning efficient delivery, and so on. For example, FIG. 24 shows one embodiment of an inventory index that is available through the user interface 58 (FIG. 2). As shown, the index shows the inventory levels associated with a single vender, “Vendor 1.” In this regard, the inventory index shows inventory levels and usages for particular marketing communications projects that have been sent to Vender 1.

The ability to track and manage inventory assists healthcare entities in managing venders as well as managing inventory ordering and storage planning For instance, the system provides healthcare entities access to in-depth information relating to inventory levels and locations so that entities may make informed decisions about how much inventory to order, from whom to order the inventory, when to order the inventory, where to store the inventory, and so on.

Following the production of the instances of the marketing communication, delivery may be made in any appropriate manner and by any appropriate party. For instance, the printing vender 105 may handle delivery through the U.S. mail or via any other appropriate delivery means. In another embodiment, an appropriate one of the service groups 101-110 of the healthcare entity 100 may handle delivery of print and/or electronic documents. Electronic documents may be delivered, for example, via email, web posting, or through access to a user account that is accessible through the entity portal 112 (FIG. 1).

In one embodiment, it may be desirable to combine two or more marketing communications into kits for grouped delivery. In this regard, the production staging management module 74 and/or the inventory management module 76 may be used to either manually or automatically kit marketing communications such that the kitted materials may be produced in house or sent to an external vender. In a manual context, users may “build” a kit by instructing the system 50 as to the marketing communications to be included in the kit. In an automatic context, a user may upload one or more kit matrices that pair each marketing communication supported by the system with one or more kits such that as marketing communications projects are completed, the system 50 is aware of any kitting associations related to the marketing communications.

### III. Developing a Marketing Communication

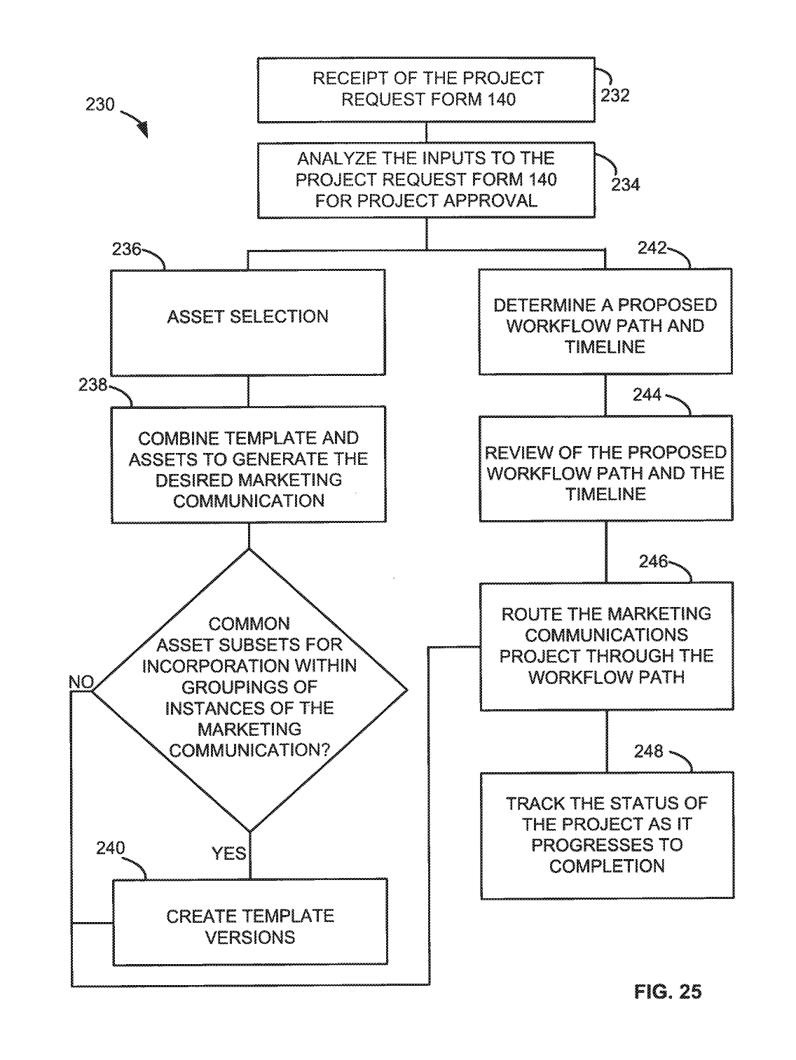

FIG. 25 illustrates an exemplary marketing communications project development protocol 230 to demonstrate the use of the publication management system 50 to manage a marketing communications project. The marketing communications project development protocol 230 follows a marketing communications project from its inception through the development process, which involves the generation, approval, production, and delivery of a desired marketing communication. The protocol 230 begins with receipt of the project request form 140 (FIGS. 6-11) that includes a number of inputs defining the desired marketing communication (232). The inputs may include an uploaded template where appropriate. Next, the inputs to the project request form 140 are analyzed and, if appropriate, the project may be approved (234). Once approved a number of assets to be combined with the template may be selected along with their corresponding rules (236). Using the rules associated with the assets, the template and the assets may be combined to create a foundational or base document for use in generating the desired marketing communication (238). If there are asset subsets that are common to one or more instances of the marketing communication, then the template may be versioned accordingly (240), as discussed above in relation to FIGS. 22-23.

In parallel with selecting the template and generating any appropriate template versions, the traffic manager and/or the system 50 may determine a proposed workflow path and timeline for the marketing communication project (242). The proposed workflow path and the timeline may be based on the inputs to the project request form 140 (FIGS. 6-11), which among other parameters, may set forth the media type of the desired marketing communication along with an intended audience, a plan type, a line of business, and one or more services that the requestor deems necessary to the development of the marketing communication (e.g., copywriting, editing and proofing, translations, regulatory approval). As discussed above in relation to the exemplary workflow management protocol 120 of FIG. 5, the system 50 may analyze the inputs to the project request form 140 to generate a series of tasks to be completed and assign one or more users to each of the tasks. The system 50 may also assign a project stage to each task to mandate when the particular task is to be completed in relation to the other tasks. By examining or integrating the tasks along with their assigned users, project stages, and the start and end dates of the project, the publication management system 50 may derive the proposed workflow path and the timeline. Any system-generated tasks, workflows, and/or timelines may be based on a collective experience of the system operator.

A traffic manager, oftentimes within the MarCom group 102, may review the proposed workflow path and timeline and, if necessary, make any revisions to the workflow path and/or the timeline based on the traffic manager's knowledge of the current status of the entity (244). In this regard, the traffic manager may revise the workflow path to accommodate special circumstances within the healthcare entity 100 of which the traffic manager is aware. For example, the traffic manager may be aware of an impending employee departure from the entity 100 or an understanding that the copywriting personnel within the MarCom group 102 and the audience champions within the compliance group 104 are behind schedule due to a high percentage of new or inexperienced employees performing those functions. In other words, the traffic manager may amend the workflow path and timeline as appropriate to account for any issues of which the publication management system 50 unaware.

Once the workflow path and the timeline are formalized, the publication management system 50 may be used to route the marketing communications project through the workflow path (246), all the while tracking the status of the marketing communications project as it progresses to completion (248). For example, assigned users within the MarCom group 102 may access and modify the template and/or one or more of the versions to add copy before editing and proofreading the resulting draft marketing communications. Next, assigned users within the compliance group 104 may submit the draft marketing communications to a regulatory body, such as CMS, for approval. In parallel with these tasks, the IT and data development group 106 may gather member contact information and formulate flat text files containing member variable information for use in customizing each instance of each version of the marketing communication. In other words, each of the assigned personnel within the service groups 101-110 may access, review, and track the performance and/or completion of their assigned tasks, and the project as a whole, through the graphical user interface 58. In addition to receiving notifications regarding tasks, deadlines, status reports, and so on through the user interface 58 of the system 50, the system 50 may send email notifications containing similar information to users that are assigned to the marketing communications project. Further, in many instances, the materials (e.g., data, document files, templates, template versions) needed to carry out the assigned tasks are available through the system 50 and accessible through the graphical user interface 58, as the publication management system 50 serves as a central repository for electronic project materials (e.g., member variable data, assets, templates, template versions).

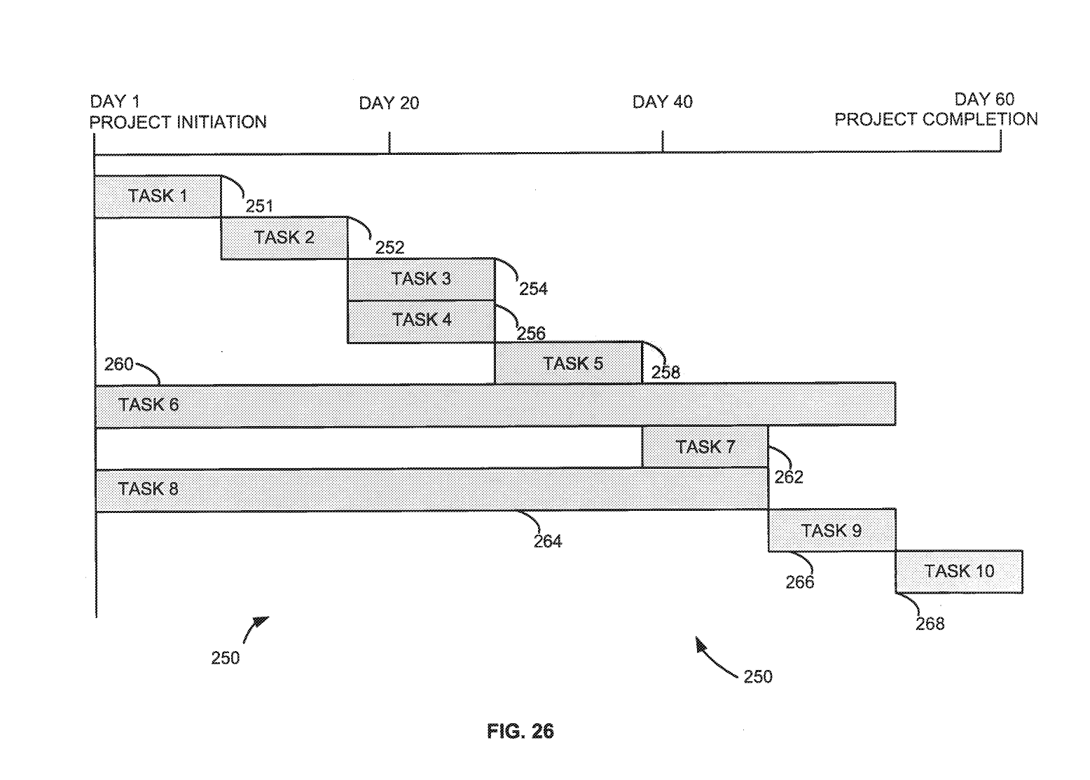

To provide an example of the routing concept, FIG. 26 illustrates an exemplary workflow path 250 for routing a marketing communications project. A first task 251 may require a first copywriter within the MarCom group 102 to draft and add copy to a first template version and a second template version. The first and second template versions may include assets that pertain to the Medicare Advantage and Medicare Part D plans, respectively. Upon notification of the project initiation (e.g., via email, via routine monitoring of the graphical user interface 58 for new projects), the first copywriter may access the first and second versions through the graphical user interface 58 and amend the respective templates to include any necessary revisions or additions to the existing copy. For instance, the first copywriter may add information about improved coverage in the upcoming plan year. Once the first copywriter has completed the first task, the homepage 162 (FIG. 15) of the graphical user interface 58 may be updated to reflect that the first task is complete.

Next, a second task 252 may require a first editor of the MarCom group 102 to review the first and second template versions for clarity and effective use of grammar and punctuation. After the first editor has completed the review, the project status may again be updated such that a first compliance officer within the compliance group 104 may see, by reviewing the graphical user interface 58, that a third and next task 254 requires the compliance officer to seek regulatory approval for the first and second versions of the marketing communication. In one embodiment, the compliance officer may then submit the first and second versions to CMS for approval. In another embodiment, the system 50 may submit, at the compliance officer's direction, electronic files reflecting the first and second versions to CMS for approval.

In parallel with the regulatory review, a fourth task 256 may require a first audience champion to review the first and second versions for appropriate, clear, and effective communication with the respective intended audiences, or members having Medicare Advantage and Medicare Part D plans, respectively. Once these third and fourth parallel tasks 254, 256 are complete, the project status may be updated in the homepage 162 of the graphical user interface 58.

A fifth task 258 may require a translations specialist within the MarCom group 102 to arrange for translations of the marketing communication into, for example, the Spanish language. As discussed above in relation to FIG. 5, some tasks, such as one or more tasks relating to translation management, may be required by state and/or federal regulations that govern marketing communications of healthcare entities.

In one embodiment, a sixth task 260 may require a first IT professional within the IT and data development group 106 to create data files (e.g., flat text files, tab or space delimited files, CSV files) that include the member variable information such as the name and contact information of an intended recipient for each instance of the marketing communication produced from the first and second versions, respectively. Because the intended recipients are defined initially, the IT professional may complete the sixth task 260 at any time prior to the delivery of the marketing communication. The IT professional or any other appropriate personnel, either within the entity or within a contracted print vender, may also be required to complete a seventh task 262, or to tokenize variations of the first and second versions such that the data files may be mapped to the tokenized variations of the first and second versions to produce multiple customized instances of the desired marketing communication, as discussed in relation to the customization protocol 210 of FIG. 23.

An eighth task 264 may require a print production specialist within the MarCom group 102 to carry out a bid process to select a print vender. As shown in the workflow path 250, this task may overlap with or be performed in parallel with one or more of the first through seventh tasks 251-262, discussed above. The print production specialist may also be assigned a ninth task 266, which requires the print production specialist to transmit, or cause the system 50 to transmit, the appropriate electronic files to the vender for production of the individual instances of the marketing communication. In one embodiment, the vender may also be responsible for a tenth task 268 of delivering the instances of the marketing communication via any appropriate delivery method.

As users complete their assigned tasks, the system 50 may lock them out of the particular marketing communications project so as to prevent disruption of the workflow should any one user attempt re-enter and impact the project at an unknown or unexpected time interval or phase of the project. Once the marketing communications project is complete, the project may be terminated and simply managed from an inventory perspective by, for instance, the inventory management module 76, discussed above.

As the project progresses through the workflow path 250, the status of the project is updated and reflected within the graphical user interface 58 for each team member to monitor and respond accordingly. Moreover, each of the personnel assigned to the marketing communications project may post announcements though the graphical user interface 58, which allows the team to communicate effectively as the project moves towards completion. Thus, in routing the marketing communications project through the workflow path 250, the publication management system 50 provides a centralized management tool for the generation, approval, production, and delivery of defined marketing communications in which each assigned user is informed of the requisite tasks to be completed through an organized workflow path over a specified timeline. The system 50 also creates draft documents (e.g., templates, template versions) to be used in generating the marketing communication and makes those documents available through a centralized, easily accessible repository.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention or other embodiments and with various modifications required by the particular application(s) or use(s) of the present invention. It is intended that the appended claims be construed to include alternative embodiments to the extent permitted by the prior art.

What is claimed:

1. A method for use in developing marketing communications for a healthcare entity, comprising the steps of:
a) establishing a computerized system for integrated publication management;
b) receiving, through a graphical user interface of said computerized system, inputs regarding a marketing communications project to generate a defined marketing communication; and
c) based on said inputs to said graphical user interface, using said computerized system for:
1) determining a workflow path and a timeline for generating, approving, producing, and delivering said defined marketing communication; and
2) routing said marketing communications project to each of a subset of service groups of said healthcare entity that are required to carry out said workflow path over said timeline.

2. A method as set forth in claim 1, wherein said marketing communication includes either a print communication or an electronic communication.

3. A method as set forth in claim 1, wherein said inputs to said graphical user interface include one or more of a plan benefit package to which said marketing communications project pertains, a media type of said defined marketing communication, an intended audience for said defined marketing communication, and a request for one or more services that are required to generate, approve, produce, or deliver said defined marketing communication.

4. A method as set forth in claim 1, wherein said subset of service groups is selected from a master set of service groups comprising a product group, a design group, a copywriting group, a proofing and editorial group, a print productions group, a translations group, a compliance group, an operations group, an inventory management group, and a customer service group.

5. A method as set forth in claim 1, further comprising using said computerized system for:
a) establishing one or more tasks for completion by each service group in said subset of service groups;
b) tracking a status of each said task; and
c) reporting said status via said graphical user interface.

6. A method as set forth in claim 1, wherein said approving comprises submitting a draft of said defined marketing communication to an external regulatory body for regulatory compliance approval.

7. A method as set forth in claim 1, wherein said approving comprises obtaining, based upon said inputs to said graphical user interface, approval from at least one of an appropriate subject matter expert, an audience champion, and a product manager.

8. A method as set forth in claim 1, wherein said producing comprises making one or more electronic or print instances of said defined marketing communication.

9. A system for use in developing marketing communications for a healthcare entity, comprising:
a publication management computer having a graphical user interface for defining a marketing communications project, said graphical user interface having input prompts, each associated with a predefined menu of user inputs, for one or more of the following:
1) a plan benefit package to which said marketing communications project pertains;
2) information identifying a media type of said project;
3) information identifying an intended audience for said project; and
4) an indication of whether managerial approval is required,
said publication management computer being configured to define and manage a comprehensive workflow path for developing said marketing communications project based on said user inputs to said graphical user interface.

10. A system as set forth in claim 9, wherein said marketing communication is a print communication or an electronic communication.

11. A system as set forth in claim 9, wherein said publication management computer is configured to route said marketing communications project to numerous service groups that comprise said comprehensive workflow path, wherein each said service group performs one or more tasks necessary to said developing said marketing communications project.

12. A system as set forth in claim 11, wherein said service groups include ones of a product group, a design group, a copywriting group, a proofing and editorial group, a print productions group, a translations group, a compliance group, an operations group, an inventory management group, and a customer service group.

13. A system as set forth in claim 9, wherein said developing said marketing communications project comprises generating, approving, producing, and delivering a marketing communication.

14. A system as set forth in claim 13, wherein said generating comprises generating a draft of said marketing communication.

15. A system as set forth in claim 14, wherein said approving comprises submitting said draft of said defined marketing communication to an external regulatory body for regulatory compliance approval.

16. A system as set forth in claim 14, wherein said approving comprises obtaining, based upon said user inputs to said graphical user interface, approval from at least one of an appropriate subject matter expert, an audience champion, and a product manager.

17. A method for managing marketing communications traffic in a healthcare entity, comprising the steps of:
a) establishing a computerized publication management system for managing a marketing communications project for developing a marketing communication;
b) using said computerized publication management system for:
1) receiving designated criteria that define said project;
2) applying pre-defined rules to said criteria to select a template for said marketing communication; and
3) identifying, from a master set of service groups for potential use in project workflows, said master set including a product group, a design group, a copywriting group, a proofing and editorial group, a print productions group, a translations group, a compliance group, an operations group, an inventory management group, and a customer service group, a project set of service groups for inclusion in a traffic flow for said marketing communications project; and
4) determining a workflow path with regard to said identified project set of service groups.

18. A method as set forth in claim 17, further comprising applying said pre-defined rules to said criteria to select one or more assets for association with said template.

19. A method as set forth in claim 18, wherein each said asset comprises an image, a logo, a content block, a copy block, a disclaimer block, an application programming interface (API) link to customer data, a header, or a footer.

20. A method as set forth in claim 18, further comprising using said computerized publication management system to generate one or more versions of said template, wherein each said version incorporates a different subset of common assets.

21. A method as set forth in claim 20, further comprising using said computerized publication system for producing one or more customized instances of each said version.

22. A method as set forth in claim 21, wherein said producing comprises submitting each said version to a print vender to print said one or more customized instances of each said version.

23. A method as set forth in claim 17, wherein said pre-defined rules are customizable for said healthcare entity or for said marketing communications project.

24. A method as set forth in claim 23, wherein when said criteria is identical, a first set of pre-defined rules results in a first template and a second set of pre-defined rules results in a second template, and wherein said first and second templates are different.

25. A method for use in managing the development regulated marketing communications for a healthcare entity, comprising the steps of:
a) establishing a computerized system for integrated publication management;
b) using said computerized system, determining a workflow path for generating, approving, producing, and delivering defined marketing communications including print and electronic communications;
c) using said computerized system in connection with said workflow path for:
1) receiving a request regarding a first marketing communication;
2) determining a subject matter area and intended audience for said first marketing communication;
3) generating a draft of said first marketing communication;
4) based on said subject matter area and intended audience, determining whether said draft requires approval from a subject matter expert, an audience champion, or a regulatory body; and
5) where said draft requires approval, obtaining said approval from one or more of an appropriate subject matter expert, an appropriate audience champion, and an appropriate regulatory body.

26. The method as set forth in claim 25, further comprising executing a fulfillment process dependent on a print or electronic nature of said first marketing communication.

27. The method as set forth in claim 25, wherein said obtaining said approval from said regulatory body comprises submitting said draft to said regulatory body for approval and tracking a status of said approval.

28. The method as set forth in claim 25, further comprising determining whether said draft requires managerial approval, and if so, obtaining said managerial approval.

29. A method as set forth in claim 25, further comprising establishing a number of service groups for potential use in connection with said defined marketing communications, said service groups including one or more of a product group, a design group, a copywriting group, a proofing and editorial group, a print productions group, a translations group, a compliance group, an operations group, an inventory management group, and a customer service group, and determining ones of said service groups for inclusion in a first workflow path for said first marketing communication.

30. A method as set forth in claim 29, further comprising:
defining a number of tasks for completion by said ones of said service groups in said first workflow path; and
tracking a status of said tasks.

31. A method as set forth in claim 25, wherein said obtaining said approval comprises submitting said draft for approval by said appropriate subject matter expert, said appropriate audience champion, or said appropriate regulatory body.

32. A method as set forth in claim 31, wherein said submitting said draft comprises electronically submitting said draft.

33. A system for managing regulated marketing communications in a healthcare entity, comprising:
a) a database storing information relating to regulations governing marketing communications for healthcare entities; and
b) a computerized publishing management system associated with said database, said computerized publishing management system configured for:
1) receiving inputs defining a proposed marketing communication;
2) based on said inputs, identifying one or more of said regulations that govern said proposed marketing communication; and
3) based on said regulations that govern said proposed marketing communication, determining a workflow path for generating, approving, producing, and delivering said proposed marketing communication.

34. A system as set forth in claim 33, wherein said generating comprises generating a draft of said proposed marketing communication.

35. A system as set forth in claim 34, wherein said approving comprises obtaining one of internal approval and external approval for said draft of said proposed marketing communication.

36. A system as set forth in claim 35, wherein said internal approval comprises approval from an appropriate subject matter expert, an audience champion, or a product manager.

37. A system as set forth in claim 35, wherein said external approval comprises approval from a regulatory body.

38. A method is provided to facilitate customization of a marketing communication, comprising the steps of:
a) establishing a computerized system for integrated publication management; and
b) using said computerized system for:
(1) receiving inputs that define a prospective marketing communication having a fixed content and a custom content, wherein said custom content varies with respect to one or more variables including an intended audience, a plan, a plan option, a plan year, a member identity, a member organization, or a member status;
(2) developing a communication template for use in obtaining approvals for said fixed content of said marketing communication;
(3) establishing a metadata repository for representing said custom content of said prospective marketing communication, wherein items of said custom content are represented by tokens in said communication template;
(4) developing a mapping structure for use in populating said items of custom content based on said variables; and
(5) producing a number of customized instances of said prospective marketing communication by obtaining a tokenized variation of said marketing communication including a content of said template and said tokens, and replacing said tokens with corresponding items of custom content based on said metadata repository and said mapping structure.

39. A method as set forth in claim 38, wherein said fixed content comprises regulated content subject to approval by a regulatory body.

40. A method as set forth in claim 39, wherein said regulatory body comprises the Centers for Medicare and Medicaid Services (“CMS”) or the United States Department of Health and Human Services.

41. A method as set forth in claim 38, wherein said approvals comprise one or more of regulatory approval, managerial approval, approval by a subject matter expert, and approval by an audience champion.

42. A method as set forth in claim 38, wherein said items of custom content include one or more of a plan name, premium information, deductible information, co-pay information, co-insurance information, benefit information, and member organization contact information.
